(19) United States
(12) Patent Application Publication
(10) Pub. No.: US 2023/0356554 A1
(43) Pub. Date: Nov. 9, 2023

(54) Combine Stability Enhancer

(71) Applicant: AGCO Corporation, Duluth, GA (US)

(72) Inventors: David Murray, Wichita, KS (US); John D. Anderson, Hesston, KS (US); Benjamin Adam Welle, Hesston, KS (US)

(21) Appl. No.: 18/044,182

(22) PCT Filed: Sep. 10, 2021
(86) PCT No.: PCT/IB2021/058242

§ 371 Date: Mar. 6, 2023

Related U.S. Application Data
(60) Provisional application No. 63/079,531, filed on Sep. 17, 2020.
(60) Provisional application No. 63/079,529, filed on Sep. 17, 2020.

(51) Int. Cl. A01D 41/127; B60G 9/02; B60G 17/015; A01D 41/12

(52) U.S. Cl. CPC B60G 17/015; A01D 41/1217; A01D 41/1226; A01D 41/127; B60G 9/02; B60G 2200/322; B60G 2300/08; B60G 2400/204; B60G 2400/41; B60G 2400/52; B60G 2400/61; B60G 2400/63; B60G 2800/9124

(57) ABSTRACT

In one embodiment, a control system for a vehicle comprising an axle having a center pivoting axis and a frame coupled to the axle at the center pivoting axis, the control system comprising: one or more controllers; a control circuit; and one or more actuators located on one side or opposite sides, respectively, of the center pivoting axis and coupled to the axle and the frame of the vehicle, the one or more actuators configured by the one or more controllers and the control circuit to prevent tipping based on forces imposed on the vehicle.

### CROSS REFERENCE TO RELATED APPLICATIONS

This application claims the benefit of the filing date of U.S. provisional Pat. Application 63/079529, “Combine Stability Enhancer,” and of U.S. provisional Pat. Application 63/079531, “Combine Unloader Balancing”, both filed Sep. 17, 2020, the entire disclosures of which are incorporated herein by reference

### FIELD

The present disclosure is generally related to vehicle stability and, more particularly, stability control in agricultural vehicles.

### BACKGROUND

Agricultural vehicles, including combine harvesters, windrowers, etc., provide a sophisticated tool for farmers in field operations. Field surface topologies range from relatively flat fields to sloped and/or undulating fields. Accordingly, the vehicles should be capable of adeptly handling these variations in driving terrain. Also, since there is often a need to drive agricultural vehicles on a roadway to reach one or more fields or return from the same, the vehicles should be capable of higher speeds and/or be of suitable width to enable unencumbered navigation of roadways, which unlike most fields, may promote advanced speeds and/or be constrained in width by natural or artificial barriers at one or more sides of the roadway.

One strategy to facilitate roadway travel is to narrow the chassis design, which is particularly useful when considering the narrow on-road width requirements in many European countries. However, if a narrower width is not combined with a lowering of the machine Center of Gravity (COG), ground speed may need to be reduced when making turns while driving at higher on-road speeds due to a reduction in vehicle stability as compared to wider configurations.

### SUMMARY OF THE INVENTION

According to an aspect of the invention there is provided a vehicle, comprising a frame, an axle coupled to the frame at a center pivoting axis, a controller, a sensor in communication with the controller, an actuator coupled to the axle and the frame, a control circuit comprising one or more control valves coupled to the actuator, each of the one or more control valves comprising an interface configured to receive control signals from the controller, wherein the controller is configured to control the actuator to apply a moment to the axle relative to the frame in response to input from the sensor to prevent tipping based on forces imposed on the vehicle.

In one embodiment this applied moment advantageously enables an increase in overall machine stability by moving stability lines, which typically run from the center of each front tire back to the center of a pivoting rear axle, out to a wider point of the rear axle on each side. How far the left and right lines move away from the center connecting point at the pivot of the rear axle is dependent on how much left or right moment is applied between the chassis and pivoting rear axle. As these lines move further away from the center of the rear axle, the side to side stability of the vehicle (e.g., combine harvester) increases relative to a vertical center of gravity point.

These and other aspects of the invention will be apparent from and elucidated with reference to the embodiment(s) described hereinafter.

### BRIEF DESCRIPTION OF THE DRAWINGS

Many aspects of certain embodiments of the disclosure can be better understood with reference to the following drawings. The components in the drawings are not necessarily to scale, emphasis instead being placed upon clearly illustrating the principles of the present systems and methods. Moreover, in the drawings, like reference numerals designate corresponding parts throughout the several views.

FIG. 1A is a schematic diagram that conceptually illustrates, in fragmentary rear elevation view, an example vehicle having a center pivoting axis and for which an embodiment of a stability control system using hydraulic actuators in a predictive tipping prevention scheme may be implemented.

FIG. 1B is a schematic diagram that conceptually illustrates, in fragmentary rear elevation view, an example vehicle having a center pivoting axis and for which an embodiment of a stability control system using air-type actuators in a predictive tipping prevention scheme may be implemented.

FIG. 1C is a schematic diagram that conceptually illustrates, in fragmentary rear elevation view, an example vehicle having a center pivoting axis and for which an embodiment of a stability control system using a spring system in a reactive tipping prevention scheme may be implemented.

FIG. 1D is schematic diagram that conceptually illustrates in fragmentary, overhead perspective view the vehicle of FIG. 1A with the unloader tube assembly.

FIG. 2A is a schematic diagram that illustrates in rear, fragmentary view, an example rear axle that may be used in an embodiment of a stability control system.

FIG. 2B is a schematic diagram of the example rear axle of FIG. 2A in a fragmentary, rear isometric view.

FIG. 3 is a logical flow diagram that illustrates an embodiment of an example stability control algorithm.

FIG. 4 is a schematic diagram that illustrates example an example combine configuration updates data structure for vehicle feature parameters.

FIG. 5 is a schematic diagram that illustrates example parameters associated with forces imposed on a vehicle having a center pivoting axis and derived from the parameters of FIG. 4 and manufacturer data.

FIG. 6 is a schematic diagram that illustrates tipping force determinations based on derived parameters and additional input including real time input for a vehicle having a center pivoting axis and traveling on level ground and making a turn.

FIGS. 7A-7B are schematic diagrams that illustrate tipping force determinations based on derived parameters and additional input including real time input for a vehicle having a center pivoting axis when parked on a slope.

FIGS. 8A-8B are schematic diagrams that illustrate tipping force determinations based on derived parameters and additional input including real time input for a vehicle having a center pivoting axis when in motion on a slope.

FIG. 9 is a schematic diagram of an embodiment of a control circuit used for effecting actuation of one or more actuators based on tipping force determinations.

FIG. 10 is a block diagram that illustrates an embodiment of an example stability control system.

FIG. 11 is a flow diagram that illustrates an embodiment of an example stability control method.

FIG. 12 is a flow diagram that illustrates another embodiment of an example stability control method.

### DESCRIPTION OF EXAMPLE EMBODIMENTS

Certain embodiments of a stability control system and associated methods are disclosed that are implemented on a vehicle having a center pivoting axis (or plural center pivoting axes) to prevent the vehicle from tipping during motion while turning or when in a precarious, static or moving state (e.g., when parked or moving on a slope). In one embodiment, the vehicle comprises an agricultural vehicle, including a combine harvester with a detachable front implement, a cab, a storage/grain bin with coupled pivoting unloader tube, and a rear center pivoting axis, where the relatively high center of gravity, particularly when the storage or grain bin is loaded at or near capacity, may pose stability challenges. Under any one of various conditions, certain embodiments of a stability control system apply a moment via an actuator (e.g., single or double-rodded piston, air bag, spring, or motor) to the center pivoting rear axle relative to the chassis/frame that includes the storage bin.

In one embodiment, the applied moment is machine-controlled and dependent on the operating conditions and features of the machine (vehicle). As an example, when operating in the field, the stability control system may not apply a moment in most situations due to the need of the rear axle to be able to allow the vehicle to roll side to side as it goes through varying terrain. However, while driving on a roadway or in hillside conditions, the stability control system provides the ability to apply a greater left or right moment between the rear axle and the chassis to improve vehicle stability dependent on one or more vehicle specific parameters, including ground speed, turning angle, machine configuration, vehicle inclination, and so on. In one embodiment, the stability control system provides control using a control algorithm that applies in real-time (e.g., immediate or substantially immediate) a determined amount of moment between the axle and chassis. Actuators used in the stability control system may include hydraulic (or pneumatic or electric) single or double piston-type actuators, hydraulic or electrical motors, or air-type actuators (e.g., suspension air bags), or in some embodiments, coils or springs of a predetermined (e.g., worst-case) spring constant may be used.

Digressing briefly, combine harvesters should have the versatility to efficiently and safely travel in the field and on roadways. In some regions, a narrower combine harvester provides a benefit of enabling ease of travel on roadways, but when possessing a higher center of gravity, may pose stability challenges when parked, or driving on, slopes in the field or taking turns at higher roadway speeds. Certain embodiments of a stability control system enables the use of narrower designs while mitigating or eliminating the risk of such vehicles tipping over. In some further embodiments, the stability control system provides for stability during deployment of an unloader tube (e.g., from its stowed position), particularly when the vehicle is located on unstable surface conditions.

Having summarized certain features of a stability control system of the present disclosure, reference will now be made in detail to the description of a stability control system as illustrated in the drawings. While a stability control system will be described in connection with these drawings, there is no intent to limit it to the embodiment or embodiments disclosed herein. For instance, though emphasis is placed on an agricultural vehicle comprising a center pivoting rear axle (e.g., a combine harvester), certain embodiments of a stability control system may be beneficially deployed in vehicles having a central pivot axis in the front, back, or multiple axles, including for vehicles within or outside of the agricultural industry. Also, the figures described below depict a single tire on each end of the axle, though it should be appreciated that multiple tires, or tracks in place of tires, may be used in some embodiments. Further, though emphasis is placed on the use of plural (e.g., two) actuators, one on each side of the center pivoting axis, it should be appreciated by one having ordinary skill in the art, in the context of the present disclosure, that a single actuator (e.g., single or double piston-type, air bag, motor) may be used on one side of the center pivoting axis to perform a similar function as performed using plural actuators. Additionally, a combine harvester utilizing an unloader tube as an implement or tool for transferring contents (e.g., grain, corn, etc.) from the storage bin to a cart or trailer are described, though it should be appreciated by one having ordinary skill in the art in the context of the present disclosure that the same or other applications using other types of vehicles with different implements and with the same or different quantity of actuators coupled between the rear axle and the frame may be used. For instance, a single actuator may be used (e.g., on the same side as the implement location) for purposes directed to preventing tipping due to deployment of the implement in a combine harvester, or for preventing tipping upon deploying a different type of implement in a different type of vehicle, where the implement swings between stowed and deployed positions. For instance, the implement may be a boom of a crane, or an extended container for discharging or receiving material (e.g., solids, fluids, gases, etc.). In some embodiments, a single actuator may be used as explained above, or plural actuators (one or more on each side of the axle) may be used. Further, although the description identifies or describes specifics of one or more embodiments, such specifics are not necessarily part of every embodiment, nor are all of any various stated advantages necessarily associated with a single embodiment. On the contrary, the intent is to cover all alternatives, modifications and equivalents included within the spirit and scope of the disclosure as defined by the appended claims. Further, it should be appreciated in the context of the present disclosure that the claims are not necessarily limited to the particular embodiments set out in the description.

Note that references hereinafter made to certain directions, such as, for example, “front”, “rear”, “left” and “right”, are made as viewed from the rear of the vehicle looking forwardly.

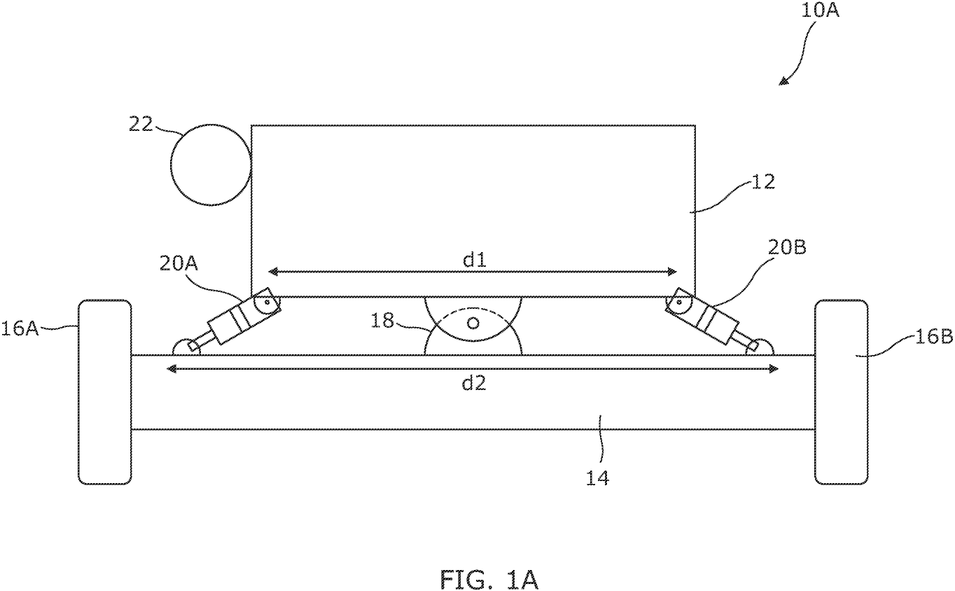

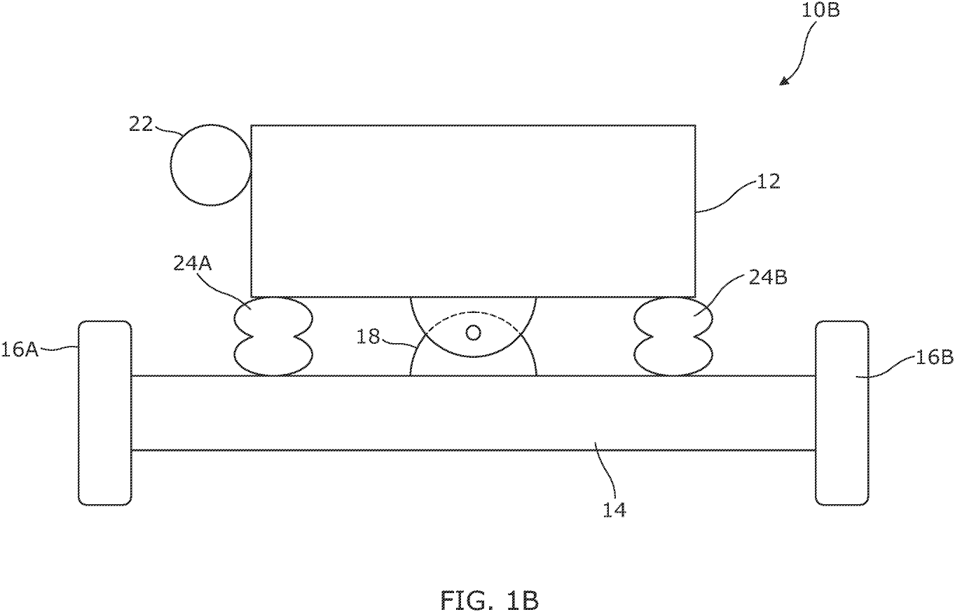

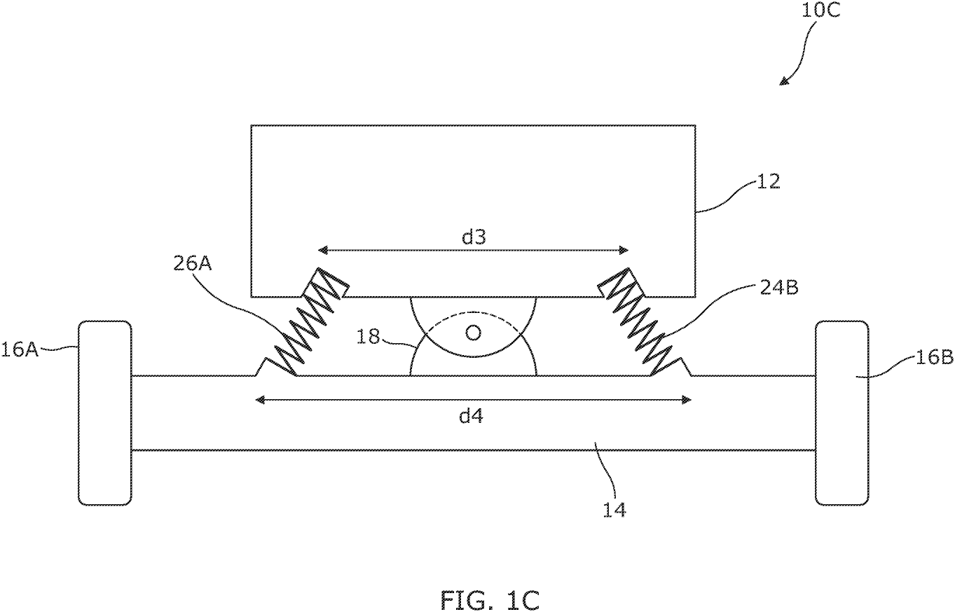

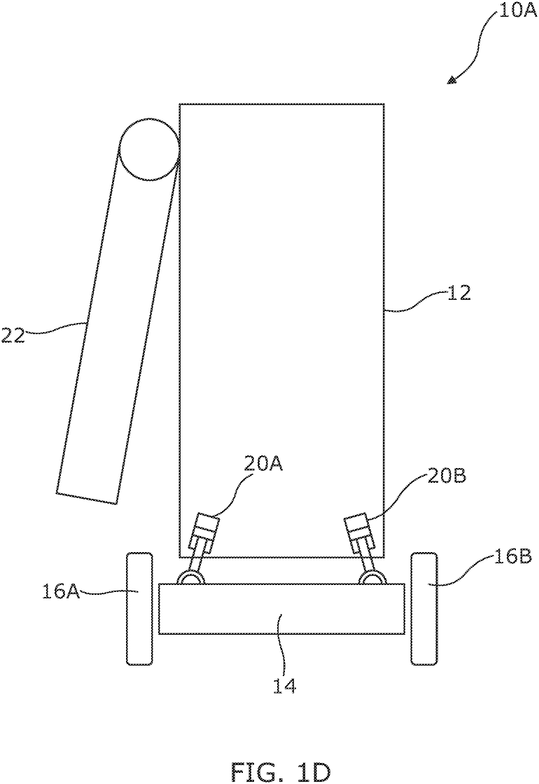

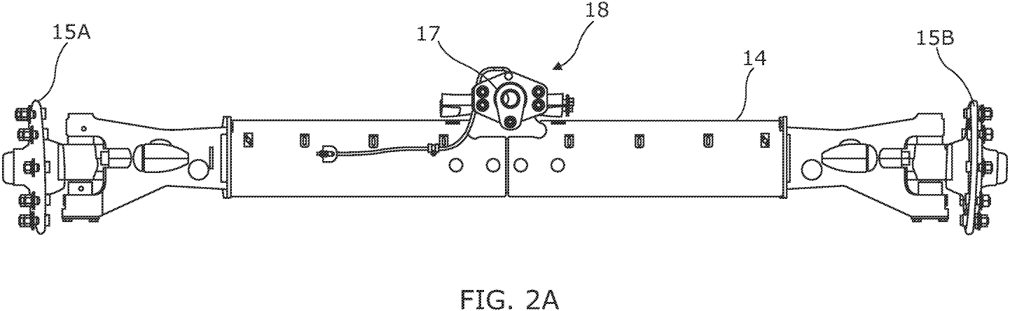

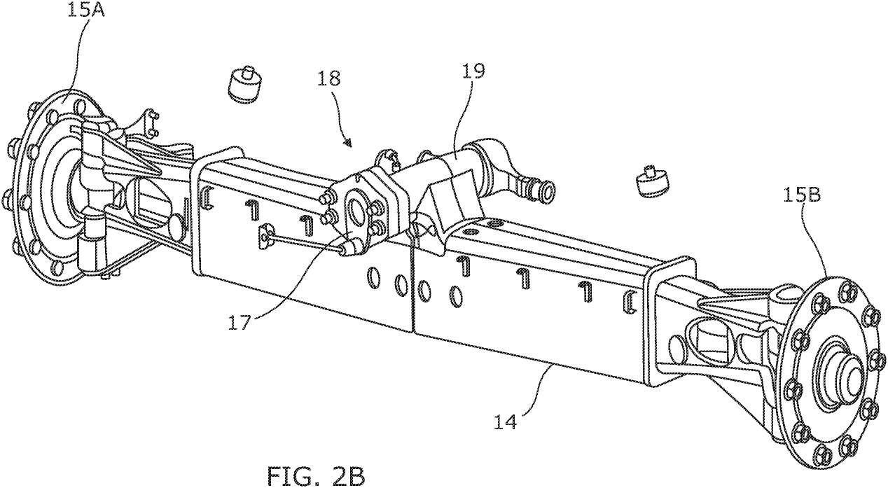

Attention is now directed to FIG. 1A, which conceptually illustrates, in fragmentary rear elevation view, an example vehicle 10A (e.g., a combine harvester) having a center pivoting axis and for which an embodiment of a stability control system using hydraulic actuators in a predictive tipping prevention scheme may be implemented. The vehicle 10A comprises a frame or chassis 12 (e.g., of a storage bin that is rearward of an un-shown passenger cab) and a rear axle 14. At each end of the rear axle 14 is a wheel hub/flange 15 assembly (shown in FIGS. 2A-2B) to which a tire 16 (e.g., 16A, 16B) is coupled. The chassis 12 and the rear axle 14 are coupled through a center pivoting axis via linkage 18 as is known. The center pivoting axis is depicted in FIG. 1A (and FIGS. 1B-1C) as being located just above the rear axle 14 in linkage 18 and extends longitudinally through the center of the vehicle 10A (e.g., representatively, the center pivoting axis extending into and out of the page of FIG. 1A, as denoted centrally on the rear axle 14 with a dot). For instance, and referring to FIGS. 2A and 2B, the linkage 18 comprises a pin 17 (e.g., a tube extending through two fixed, opposing coupling portions that sandwich a center portion 19, the coupling portions comprising bolts (or other affixing mechanisms) that attach to the chassis 12. Disposed between the pin 17 and the center portion 19 is a bushing that enables the center portion 19 to rotate with the rear axle 14, resulting in the center pivoting action as is known. The center pivoting axis enables vertical motion of the tires 16 about the center pivoting axis and rear-wheel steering. Note that the location of the center pivoting axis may be located anywhere vertically relative to its depicted position and between the rear axle 14 and the chassis 12, and that the location of the center pivoting axis as shown in FIGS. 1A-1C (and FIGS. 2A-2B) is illustrative of one example embodiment.

Coupled between the chassis 12 and the rear axle 14 are plural (e.g., two) actuators 20 (e.g., 20A, 20B). For instance, the actuators 20 are disposed (e.g., equidistantly) on each side of the center pivoting axis, and in one embodiment, extend slightly outward, from suitable mounts at the lower, outer portions of the chassis 12, directly or substantially directly in a vertical plane extending above the rear axle 14 to suitable mount locations proximal to the respective ends of the rear axle 14, such that the lateral dimension (d1) between the actuators 20A, 20B at coupling locations to the chassis 12 is smaller than the lateral dimension (d2) where the actuators 20A, 20B couple to the rear axle 14. In some embodiments, the actuators 20 may be located and oriented in a different manner than depicted in FIG. 1A. For instance, assuming an imaginary circle around the center pivoting axis, the actuators 20 may be disposed and oriented between the chassis 12 and the rear axle 14 in a manner that is tangential to the circle. In the depicted embodiment, the actuators 20 each comprise a hydraulic, double-acting piston and rod type actuator, though in some embodiments, other types of actuators using a different motive source (e.g., electrical, pneumatic, etc.) and/or different action (e.g., single action, rotary action, etc.) may be used if of sufficient stroke/actuation speed to be acted (e.g., immediately) upon to prevent tipping. As explained above, in some embodiments, a single actuator 20 (e.g., 20A or 20B) may be used on only one side of the center pivoting axis and is operable in combination with the linkage 18 to prevent tipping. The actuator 20 may be any one of those described above and similarly located, or in some embodiments, a double-rodded piston-type actuator may be used.

Also representatively shown is an unloader tube 22 coupled to, and stowed along side of (extending substantially fore and aft), the chassis 12. FIG. 1D further conceptually illustrates in overhead, fragmentary perspective view the unloader tube 22, with like numbers corresponding to features among the several views. The unloader tube 22, when deployed (e.g., swung out), provides conveyance (e.g., via one or more augers, not shown) of the material collected in a grain bin or storage (shown in a closed position) out of the end of the unloader tube 22 to a trailer or cart. The forces imposed by the extending or extended lever arm represented by the unloader tube 22 may need to be countered in some embodiments to prevent tipping of the vehicle 10A, as explained further below. Notably, FIG. 1D is a conceptual rendering (e.g., one would not expect to see the actuators 20 from above the vehicle 10A), and is used merely to reveal the positioning and extent of the unloader tube 22 relative to the side of the vehicle 10A, as the positioning and orientation of the unloader tube 22 would be understood by one having ordinary skill in the art.

In one example operation, when the stability control system determines that operating conditions are such that there is a risk of tipping (e.g., side-to-side), the stability control system causes one of the actuators 20 (or activates both in coordinated fashion in some embodiments) to provide a moment between the chassis 12 and the rear axle 14 on the left or right side of the axle pivot. One condition where there is the potential for instability is when the vehicle 10A is traveling on a roadway (or in some applications, along a relatively level, even surface in a field) and begins to negotiate a turn at a higher speed (and risks one of the tires lifting from the surface). Another condition where there is the potential for instability is when the left and right side of the vehicle 10A are at different heights (e.g., when the vehicle 10A is moving or stationary on a slope in the field), particularly when the wheels are turned. Yet another condition where there is the potential for instability is when the unloader tube 22 is deployed on a slope or uneven ground. One or a combination of these different conditions may occur, with or without an attached implement (e.g., header), and are addressed by an embodiment of a control algorithm as described further below.

In FIG. 1B, shown is a schematic diagram that conceptually illustrates, in fragmentary rear elevation view, an example vehicle 10B having a center pivoting axis and for which an embodiment of a stability control system using air-type actuators in a predictive tipping prevention scheme may be implemented. The vehicle 10B is of a similar structure to that shown in FIG. 1A, and comprises a frame or chassis 12 and a rear axle 14 with tires 16 (e.g., 16A, 16B) mounted to wheel hub/flange assemblies coupled to respective ends of the rear axle 14. The chassis 12 and the rear axle 14 are coupled via linkage 18 through the center pivoting axis (denoted using a dot in FIG. 1B) as is known and described similarly above with respect to FIGS. 1A and 2A-2B, and omitted here for brevity. Also, as similarly described above, the center pivoting axis may be elsewhere along a vertical line extending upwards or downwards from the dot in some embodiments. Coupled between the chassis 12 and the rear axle 14 are plural (e.g., two) actuators 24 (e.g., 24A, 24B). For instance, the actuators 24 are disposed (e.g., equidistantly) to suitable mounts on each side of the center pivoting axis, and in one embodiment, extend vertically or substantially vertically down from the lower, outer portions of the chassis 12 that is situated directly or substantially directly (e.g., in a vertical plane) above the rear axle 14 to corresponding mount locations of the rear axle 14, such that the lateral dimension between the actuators 24A, 24B at coupling locations to the chassis 12 is about equal to the lateral dimension where the actuators 24A, 24B couple to the rear axle 14. As similarly described above, the orientation and/or location of the actuators 24 may differ in some embodiments, and may be determined based on a tangent to an imaginary circle centered at the center pivoting axis or according to other placement/orientation methods. In the depicted embodiment, the actuators 24 comprise air-type actuators (e.g., air suspension bags). In some embodiments, as similarly described above, only a single actuator 24 may be used in cooperation with the linkage 18 to prevent tipping. Also shown (similarly to FIG. 1A) is an unloader tube 22 coupled to, and stowed along side of (fore and aft), the chassis 12.

In one example operation, when the stability control system determines that operating conditions are such that there is a risk of tipping (e.g., side-to-side), the stability control system causes one (or in some embodiments, via actuation of both, such as to release air in one and supply air to another) of the actuators 24 to provide a moment between the chassis 12 and the rear axle 14 on the left or right side of the axle pivot. Further description of the control algorithm is provided below.

Referring now to FIG. 1C, shown is a schematic diagram that conceptually illustrates, in fragmentary rear elevation view, an example vehicle 10C having a center pivoting axis and for which an embodiment of a stability control system using a spring system in a reactive tipping prevention scheme may be implemented. The vehicle 10C is of a similar structure to that shown in FIG. 1A, and comprises a frame or chassis 12 and a rear axle 14, along with a tire 16 (e.g., 16A, 16B) mounted to a wheel hub/flange assembly (not shown) at each end of the rear axle 14. The chassis 12 and the rear axle 14 are coupled via linkage 18 through the center pivoting axis (denoted with a dot in FIG. 1C) as is known and as similarly described above for FIGS. 1A-1B (and FIGS. 2A-2B). Coupled between the chassis 12 and the rear axle 14 are plural (e.g., two) coils/springs 26 (e.g., 26A, 26B). For instance, the springs 26A, 26B are disposed on each side of the center pivoting axis, and in one embodiment, extend slightly outward from the suitable mounts on the lower, substantially outer portions of the chassis 12 directly or substantially directly above (e.g., in a vertical plane extending to) the rear axle 14 to mount locations proximal to the respective ends of the rear axle 14, such that the lateral dimension (d3) between the springs 26A, 26B at coupling locations to the chassis 12 is smaller than the lateral dimension (d4) where the springs 26A, 26B couple to the rear axle 14. The location and/or orientation of the springs 26A, 26B may be arranged in a manner different than that depicted in FIG. 1C (e.g., using an imaginary circle centered at the pivoting axis and using a tangential placement, etc.). It is noted that the springs 26 may have a cup design that is disposed on each end of the spring that enables compensation for any misalignment, as is known. In effect, this system may be viewed as a lever arm and center pivot pin assembly, where the rear axle 14 serves as a lever arm and the pin is the pivot that the rear axle 14 moves on in relation to the chassis 12. Unlike the actuators 20 (FIG. 1A) and 24 (FIG. 1B), the spring/coil type actuators 26 are passive, reactive type actuators, providing a reactive tipping prevention scheme. In some embodiments, only a single spring 26 (e.g., 26A, 26B) is used in cooperation with the linkage 18, as described similarly above.

In practice, and in one embodiment, a trend line from data associated with various tipping forces and moment data may be used to enable selection of a spring rate value to best fit what is needed to enable vehicle stability. The springs 26 are reactive to tipping forces (e.g., a reactive tipping prevention mechanism), whereas the actuators 20, 24 are predictive (e.g., a predictive tipping prevention scheme) and use such parameters as vehicle speed or velocity, angle of combine, and angle of turn (e.g., steering angle) desired to get the moment sent to the axle 14 before the chassis 12 experiences it. Also shown is an unloader tube 22 coupled to, and stowed along side of (fore and aft), the chassis 12.

Note that in one embodiment, the actuators 20, 24 and the springs 26 are the only components dictating the forces between the chassis 12 and the rear axle 14 (e.g., there is no other suspension components between the chassis 12 and the rear axle 14, since suspension components are typically used in association with the cab of the vehicle 10). In some embodiments, there may be suspension components disposed between the rear axle 14 and the chassis 12 that are used in conjunction with the actuators 20, 24 and/or springs 26. Notably, the actuators 20, 24 or springs 26 are intended for stability purposes only, though in some embodiments, may (e.g., actuators 20, 24) provide some ancillary suspension (e.g., damping) benefits.

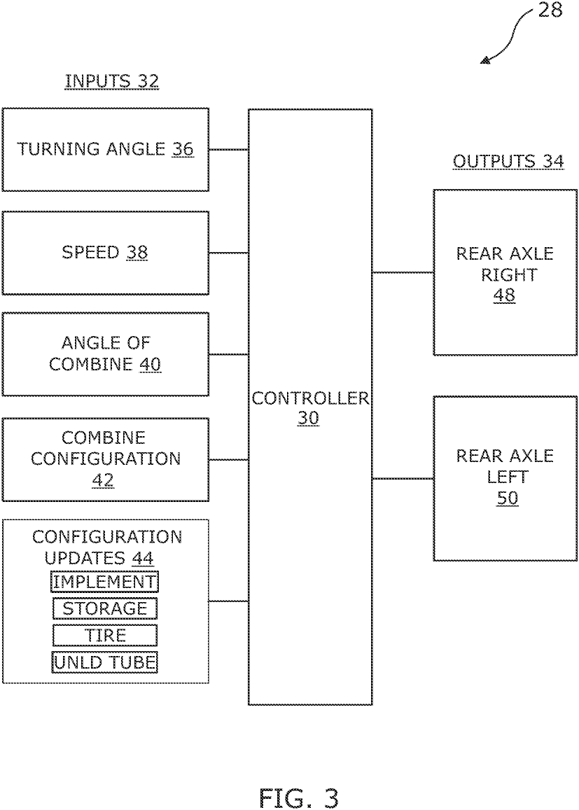

FIG. 3 is a logical flow diagram that illustrates an embodiment of an example stability control algorithm 28. In some embodiments, the stability control algorithm 28 may have fewer, additional, and/or different inputs and/or outputs. In the depicted embodiment, a controller 30 receives inputs 32, performs processing on those inputs or values derived from the inputs, and generates outputs 34. Assuming the vehicle 10 (FIG. 1A) serving as a host for the stability control algorithm 28 to be a combine harvester, in one embodiment, the inputs 32 include turning angle 36, ground speed 38, angle of inclination of the combine harvester 40, combine configuration 42, and configuration updates 44. One or more of the inputs 32 may comprise real time (e.g., immediate) inputs, including sensor input and/or operator input (e.g., via a user interface). The outputs 34 include a rear axle right moment 48 and a rear axle left moment 50 (and in some embodiments, notification of the outputs to the operator and/or saved in memory). In some embodiments, a single moment on one side or the other may be used based on the use of a single actuator on either side of the center pivoting axis, as described above.

Sensors on the combine harvester may be used to provide the speed 38 (e.g., using any one or a combination of a Global Navigation Satellite System (GNSS) receiver, transmission/transaxial sensor, inertial components, etc.) and the angle of inclination 40 (e.g., using an inclination or tilt sensor). The turning angle 36 is the angle requested by the machine or user, and may be an inputted value communicated to or between software components or modules (e.g., automated steering/auto-guidance), an input via user entry at a user interface (e.g., steering wheel, joystick, etc.), or both.

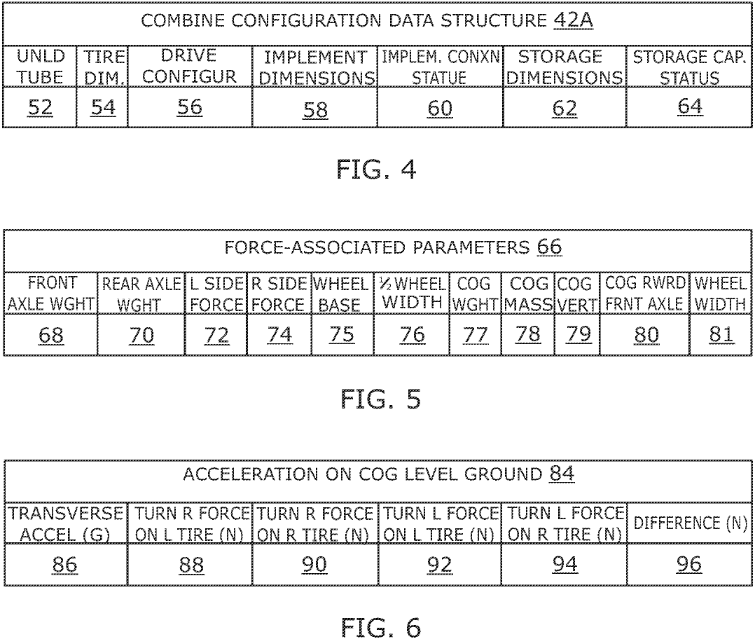

With continued reference to FIG. 3, and referring also to FIG. 4, the combine configuration 42 may include field entries for a first set of parameters that are stored in a combine configuration data structure 42A (or data structures) residing in data storage (e.g., memory) in the combine harvester or elsewhere (e.g., remote server, personal communications device, etc., where telemetry on or associated with the combine harvester may be used to access the information). The first set of parameters, referred to herein also as vehicle feature parameters, are parameters that may vary from vehicle-to-vehicle, or may vary from application-to-application for a single vehicle. The first set of parameters are used along with manufacturer data (e.g., weight measurements administered at the factory) by the controller 30 to determine (e.g., derive) a second set of parameters that are associated with real time (e.g., immediate) determinations of stability/instability and appropriate moment determinations to prevent tipping. The vehicle feature parameters are shown in the data structure 42A stored in memory of, or associated with, the controller 30, and in one embodiment includes unloader tube information 52 (e.g., a status bit or value indicating whether the tube has been activated or deployed or not, and if deployed, an angle of deployment or an indication of full extension or deployment), tire dimensions 54, drive configuration 56 (e.g., rear, two wheel drive, four wheel drive, etc.), implement dimensions 58 (e.g., header dimensions or specifications, and/or in some embodiments, additional information including manufacturer, style or type, and/or model number), implement connection status 60, storage or grain bin dimensions 62, and storage capacity status 64 (e.g., percent fullness). The implement connection status 60 may be used in some embodiments to determine whether a derived second set of parameters will use the weight/dimensions of a detachable implement or not in subsequent tipping force determinations. Similarly, whether the unloader tube is deployed or not is used to determine whether the forces associated with the deployed unloader tube are used in the second set of parameters (e.g., as opposed to basing the second set of parameters on the forces associated with a stowed unloader tube). In some embodiments, fewer, additional, or other parameters may be stored in association with the combine configuration 42 or otherwise. For instance, a vehicle identification number may be stored, which when scanned or otherwise entered into the system, may provide information about, or in addition to, the other parameters depicted in FIG. 4.

The first set of parameters correspond to inputs that may influence the stability of the combine harvester, and hence may be used along with manufacturer data in deriving a second set of parameters associated with tipping forces. For instance, a narrower tire may offer less stability for the combine harvester than a wider tire, or dual-tire configurations may provide more stability than a single tire. As to drive configuration, four wheel drive is generally heavier than a two wheel drive configuration, and is often used on vehicles with a lower center of gravity (and hence more weight that is closer to the ground, which generally improves stability). The storage, and its capacity, is likewise relevant to stability determinations. For instance, as the grain bin fills with grain, the combine harvester becomes heavier, but the center of gravity also rises, which may result in a lowered stability as a net effect. An attached implement may improve stability, depending on whether the implement is raised or lowered. In some embodiments, the deployment of the unloader tube 22 (FIG. 1A) may be relevant to the stability of the combine harvester (e.g., change in center of gravity), particularly when deployed on a slope or undulating surfaces. In some embodiments, additional vehicle feature parameters may be stored (e.g., fuel tank, chopper and/or spreader equipment, etc.).

In one embodiment, one or more of the vehicle feature parameters in data structure 42A (e.g., tire dimensions 54, drive configuration 56, storage dimensions 62) may comprise initial or default manufacturer data established (e.g., through weight measurements) at the vehicle manufacturing factory or elsewhere (at the component vendor and uploaded as data at the vehicle manufacturing factory) and stored in memory associated with the controller 30. In some embodiments, and re-directing attention to FIG. 3, updates 44 to the combine configuration 42 (and hence data structure 42A) may be performed by the controller 30 (e.g., storage capacity status 64), where value-less or zero-valued fields (or worst-case in some embodiments) of the data structure 42A comprising the vehicle feature parameters may be updated based on post-factory inputs and/or initial or default values may be overwritten. For instance, the controller 30 may update one or more fields of the data structure 42A containing the combine configuration 42 based on operator and/or sensor input. In some embodiments, entries of the data structure 42A may have an associated time-stamp to ensure the most recent data. For instance, after the combine harvester has shipped from the factory, if an operator of the combine harvester (e.g., owner, manager, contractor, vehicle operator, service technician, etc.) replaces the factory-provided tires with tires of a different size, the operator may commence a ground drive calibration, which is used through one or more sensors to determine a circumference of the tires to get the ground drive set up (e.g., using the circumference to get the new tire type that is installed on the front and/or rear axle) and update the combine configuration 42 (via updates 44). In some embodiments, the operator may input the tire type and/or dimensions at a user interface of the combine harvester during or after installation, resulting in updates 44 to the combine configuration 42. In some embodiments, one or more sensors (e.g., contact sensors) may be used to detect when a rim is taken off, which is signaled to the controller 30, which in turn communicates (e.g., via a user interface) a prompt after that sensor is triggered to request operator input regarding the installed tire information or activates an optical scan (e.g., a scanned manufacturer serial number may be computer-translated to weights and/or dimensions). Such information or updates 44 may be used to update the combine configuration 42 (e.g., to update the data structure 42A).

For updated implement information (e.g., implement or header sizing, connection status, etc.), the controller 30 may receive updates 44 based on sensed cylinder pressure information (e.g., using a pressure transducer, strain gauge, etc., whether integrated or externally attached to the cylinder). The controller 30 may use, for instance, updates 44 in the form of header lift cylinder pressure at a given feeder house position (e.g., using transducers at the lift cylinders and an angle sensor at the feeder house) to calculate a size or weight of the header detachably connected to the combine harvester, and in turn, update the combine configuration 42 for the header information. In one embodiment, the controller 30 checks the cylinder pressure based on the detection of an electrical hook-up, or in some embodiments, samples (e.g., upon engine start) the lift cylinder pressure (e.g., in implementations where the combine does not have header sensing). In some embodiments, bar code information located within view of an optical sensor positioned on the combine harvester may be scanned (e.g., when within range of the optical sensor) and from the bar code information, the specification (e.g., dimensions, weight, type of header, etc.) may be provided to the controller 30 as the updates 44.

In some embodiments, updates 44 may include information about grain bin or storage capacity status 64 (e.g., percentage of fullness). For instance, two paddle sensors located at different heights within the grain bin of the combine harvester may provide the updates 44 to the controller 30, which uses the sensors to determine a measure of fullness. In one example implementation, if no sensors are triggered, the controller 30 assumes a current capacity status of 0-80% full. If one paddle sensor is triggered, the controller 30 assumes 80% full, and if both paddle sensors are triggered, the controller 30 assumes 100% full. Note that the values or delineation or span of ranges used herein are illustrative of an example implementation, and that in some embodiments, additional and/or other values or range information may be used. In some embodiments, additional, fewer, or different (e.g., optical) sensors may be used. This information is useful for center of gravity determinations.

The unloader tube information 52, and in particular, an indication of when deployed, is updated 44 as well using one or more sensors (e.g., reed switch, optical sensor, magnetic sensor, etc.) at or proximal to the unloader tube 22 (FIG. 1A). For instance, activation of the unloader tube 22 may be received at the configuration updates 44 and prompt a corresponding change in a bit setting for the unloader tube information of the combine configuration data structure 42A, which in turn prompts a re-derivation of the second set of parameters whereby the change in forces associated with the combine harvester and the deploying or deployed unloader tube 22 are recalculated to determine the risk of tipping. In one embodiment, the re-calculated forces may be based on a fully deployed unloader tube 22 (regardless of the swing angle of the unloader tube 22), which in effect uses a worst-case force scenario even where the unloader tube 22 has not yet been fully extended. In some embodiments, the forces may be continuously updated at a plurality of positions between leaving a cradle of the unloader tube 22 (e.g., when stowed) and the fully-extended position.

Note that in some embodiments, one or more of the information described above as updated via the controller 30 using updates 44 may not be provided initially as a factory (default) setting (e.g., manufacturer data) to be overwritten in the combine configuration 42. In other words, there may be no initial field entry (or a worst case value) in the combine configuration data structure 42A for, say, the implement information (e.g., implement dimensions 58), and only populated in the combine configuration data structure 42A when the updates 44 provide the information. Additionally, it is noted that during vehicle road and/or field operations, the combine configuration 42 may be regularly (e.g., regularly sampled every fraction of a second, second(s), minute(s), etc.), and/or irregularly or conditionally updated, such as based on sensor or operator input, including detected changes in a geofence location, unloader tube deployment, change in storage capacity status, change in implement connection status, etc. In some embodiments, one or more parameters may be stored in a separate data structure(s) (e.g., separate from the data structure 42A) associated with vehicle operations.

With continued reference to FIGS. 3-4, attention is now directed to FIG. 5, which illustrates example force-associated parameters 66 (referred to also above and below as a second set of parameters or derived parameters) derived from the first set of parameters of the combine configuration 42 (including updates 44) and manufacturer data (e.g., specifications of the vehicle, including factory-measured weight values). The controller 30 receives the combine configuration 42, including updates 44, and, using classical (e.g., static) physics mechanics equations and factory-measured or obtained specifications (e.g., weights, chassis dimensions, etc.) for the combine harvester that are updated using the values from the combine configuration 42, computes the force-associated parameters 66 associated with static forces imposed on the combine harvester. The force-associated parameters 66 may be stored in one or more data structures that in one embodiment are used for an on-going (e.g., regularly or continually computed during vehicle operations, such as using sub-second sampling intervals) determination of tipping forces as the combine harvester is operated under different conditions. In one embodiment, the force-associated parameters 66 for the combine harvester include front axle weight (in Newtons (N)) 68, rear axle weight (N) 70, left-side force (N) 72 (which in the combine harvester, includes the unloader tube assembly weight), right-side force (N) 74, wheel base 75 (mm), half (½) wheel width (mm) 76 (e.g., tire center-to-tire center dimension between the outside opposing (relative to center pivoting axis) tires divided by two), center of gravity (COG) weight (N) 77 (e.g., equal to the summation of the front axle weight 68 and rear axle weight 70), COG mass (kilograms or kg) 78 (e.g., which is the COG weight divided by 9.81), COG distance vertical above ground with tires (millimeters, mm) 79, COG distance from center of front axle (millimeters, mm) 80, and wheel width (mm) 81 (e.g., tire center-to-tire center dimension between the outside opposing tires).

Note that the forces may include forces associated with an attached header or without the attached header, or with the unloader tube 22 deployed or in the stowed position, depending on the combine configuration 42 (including updates 44). For instance, the force-associated parameters 66 may comprise one set of data for implementations where the combine harvester is being driven without an attached header along a roadway, and a different set of data when operating with an attached implement while travelling on level ground or on a slope, and yet a different set of data when the unloader tube 22 is activated. In some embodiments, one or more other and/or additional COG-related dimensions may be computed, including COG distance rearward from front axle. The force-associated parameters 66 may be used in stability determinations/tipping force determinations. For instance, the wheel base 75 is important to stability determinations, since moment equations are based in part off of the wheel base when determining the forces needed to prevent tipping. Similarly, the mass at the center of gravity 78 and the COG distance vertical above ground with tires 79 have importance in determinations of tipping equations. The pertinence of these and/or other parameters are evident from the equations described below. Further, note that these values may change continuously, such as during field operations where the storage bin is progressively filled and emptied.

In one embodiment, the stability control algorithm 28 uses the force-associated parameters 66 and additional inputs including real time inputs (e.g., turning angle 36, speed 38, and angle of combine 40 from FIG. 3) to predict when there is a risk of tipping, and provides suitable real time countering measures in the form of controller-derived moments through a control circuit and actuators (as explained further below) to the right rear axle 48 or left rear axle 50. There are various scenarios where application of these moments may be used, and the following examples provide a general illustration of some of these scenarios and how the stability control algorithm 28 functions in certain embodiments to ensure stable operations. One scenario involves the use of the combine harvester on roadways, such as to travel in between fields. When a combine harvester is to negotiate a turn, the risk of tipping rises when the speed at which the turn is negotiated is increased. The risk of tipping rises even further for a relatively narrower chassis design and/or increases in the vertical distance of the center of gravity relative to ground. To reduce the risk of tipping during roadway (or field) turns (e.g., for level or substantially level ground), in one embodiment, the stability control algorithm 28 determines the acceleration on the center of gravity.

Referring now to FIG. 6, with continued reference to FIGS. 3 - 5, shown is a schematic diagram that illustrates example acceleration force parameters 84 corresponding to computed forces imposed on the center of gravity of the vehicle for acceleration on level (or substantially level) ground. In one embodiment, the controller 30 computes values for the acceleration force parameters 84 regularly (e.g., incrementally or continuously, such as via sub-second sampling) based on the second set of parameters and additional inputs, including real time inputs, as the combine harvester is traveling on a roadway. Control of vehicle motion may be via automated steering (e.g., GNSS or geo-location based motion) or via steering with an intermediate software component between the user interface (e.g., joystick) and the physical steering mechanisms. In some embodiments, control of vehicle motion may be via strictly manual steering (e.g., no intermediate software component). The acceleration force parameters 84 are particularly relevant for determining tipping forces for turns on roadways, including whether the combine harvester does or does not have a connected, detachable implement (e.g., accounted for in the determination of force-associated parameters 66). In one embodiment, the acceleration force parameters 84 comprise transverse acceleration on COG (e.g., G force on the center of gravity of the vehicle) 86, a turning right force on the left tire (N) 88, a turning right force on the right tire (N) 90, a turning left force on the left tire (N) 92, and a turning left force on the right tire (N) 94. In one embodiment, the turning right force on the left tire 88 (F_{RL}) may be determined by the following equation (Eqn. 1):

$${\text{F}}_{\text{RL}} \text{=} \left[\text{a} / 2\right] \text{+} \left[\text{a*} \left(\text{b} / \text{c}\right)\right] \text{+} \left[{\text{a*d}}_{\text{1}} \text{*} \text{e} / \text{c}\right] \text{,} \qquad \text{(Eqn. 1)}$$

where a = COG mass * 9.81, b = COG distance from center of front axle horizontal, c = wheel width (e.g., center of tire-to-center of tire for most exterior tires on opposite sides of the center pivoting axis), d₁= transverse acceleration on COG, and e = COG distance vertical above ground with tires. Note that values for some variables for Eqn. 1 are accessed by the controller 30 from the force-associated parameters 66, including COG distance vertical above ground with tires (e) 79, COG distance from center of front axle (b) 80, and wheel width (c) 81. Also, the controller 30 computes values for at least one variable in Eqn. 1, for instance, transverse acceleration on COG (d₁) 86, based on real time, sensor inputs corresponding to requested turning angle 36, speed 38, and angle of the combine 40 (e.g., and the summation of acceleration vectors according to classical (e.g., dynamics) physics mechanics). For instance, the G force may be computed using a well-known centripetal acceleration equation (a = v^2/r, where a is the acceleration, v is the velocity, and r is the turning radius that may, in some embodiments, be computed on-the-fly or via a look up table (LUT) based off of a steering angle and axle spacing (e.g., rear wheel width)). In some embodiments, the transverse acceleration may be a value computed by one or more processors of another device or sub-system(s) (e.g., inertial components), with the value inputted to the controller 30.

The turning right force on the right tire 90 (F_{RR}) may be determined from the following equation (Eqn. 2):

$${\text{F}}_{\text{RR}} \text{=f} \text{} - {\text{F}}_{\text{RL}} \text{,} \qquad \text{(Eqn. 2)}$$

where f is equal to COG weight (77 from FIG. 5). In other words, in one embodiment, the controller 30 computes F_{RR} based on F_{RL} (from Eqn. 1) and the COG weight 77 (FIG. 5).

The turning left force on the left tire 92 (F_{LL}) may be determined from the following equation (Eqn. 3):

$${\text{F}}_{\text{LL}} \text{=} \left[\text{a} / 2\right] \text{+} \left[\text{a*} \left(\text{b} / \text{c}\right)\right] \text{-} \left[{\text{a*d}}_{\text{1}} \text{*} \text{e} / \text{c}\right] \text{,} \qquad \text{(Eqn. 3)}$$

where variables a-d₁ are as described above. Similar to the explanation above, values for some variables for Eqn. 3 are accessed by the controller 30 from the force-associated parameters 66, and the controller 30 computes values for at least one variable in Eqn. 3 (e.g., transverse acceleration on COG (d₁) 86) based on real time, sensor inputs corresponding requested turning angle 36, speed 38, and angle of the combine 40. In some embodiments, values may be computed elsewhere and provided to the controller 30 as similarly explained above.

The turning left force on the right tire 94 (F_{LR}) may be determined from the following equation (Eqn. 4):

$${\text{F}}_{\text{LR}} \text{=} \text{f} - {\text{F}}_{\text{LL}} \text{,} \qquad \text{(Eqn. 4)}$$

In other words, in one embodiment, the controller 30 computes F_{LR} based on F_{LL} (from Eqn. 3) and the COG weight 77 (FIG. 5).

The difference 96 is based on the absolute value of F_{LL} 92 - F_{LR} 94, and may be used to determine effects of the different G-forces. In some embodiments, the difference 96 may be omitted..

In one embodiment, while the combine harvester is in motion, the controller 30 regularly (e.g., continuously) computes F_{RL}, F_{RR}, F_{LL}, and F_{LR} and compares the computed values to respective threshold tipping force values (e.g., corresponding to when, with a predefined safety margin, left or right forces overcome the weight of the combine harvester and cause the left or right tire to lift off of the ground) that indicates that the controller 30 should effect a rear axle right 48 and/or left 50 moment to prevent tipping. In some embodiments, the controller 30 performs these computations as multiple threads that are run substantially in parallel. In some embodiments, the controller 30 may only commence computations for Eqns. 1-4 based on detected set of conditions. For instance, computations may be commenced after a threshold requested or sensed turning angle 36, speed 38, and/or angle of combine 40.

Explaining operations according to one embodiment for negotiating a turn on a level surface (e.g., roadway), the controller 30 may continually track acceleration or G forces on the center of mass of the combine harvester. When viewing the equations 1-4 from the perspective of forces imposed on the tires, it is expected that, should the combine harvester turn right for instance, the force on the left tire is greater than the force on the right tire (the center of gravity influencing a leftward force). As the G forces increase going into, or are expected or predicted to go into (e.g., based on requested steering angle or anticipated steering angle in the case of auto-guidance) a turn, the risk of tipping increases. Stated otherwise, as acceleration increases, there is a point where the left tire in this example may experience a higher force than the weight of the combine harvester, which would cause the right tire to lift off of the ground (and hence reach a tipping force). To prevent tipping, the controller 30 effects application of the rear axle left moment 50 (via a control circuit and actuator) in the amount of at least the difference between the combine weight and the force imposed on the left tire (and in some embodiments, a defined percentage or safety margin of force). In other words, the rear axle left moment 50 is designed to keep the right tire on the ground in this scenario. In one embodiment, the applied moment is predictive, where the controller 30 effects actuation of the moment based on a rapidly approaching or predictive trend to this condition, or based on a predefined trigger (e.g., threshold transverse acceleration, or other parameters), or otherwise based on predicting this event according to other predictive mechanisms (e.g., using artificial intelligence, such as a neural network). In some embodiments, the moment may be applied in a more reactive fashion, assuming sufficient processing speed and hence reaction time.

In some embodiments, the controller 30 may continually compare the inputted real time values to find a match to a set of parameters within one of one or more regularly updated, pre-populated data structures (e.g., look-up-tables or LUTs) that have a plurality of fields with data entries for acceleration force parameters 84 for a plurality of different values or ranges for transverse acceleration 86. These pre-populated values may be based on the combine configuration 42 and updates 44 computed each time the combine harvester is powered up, or each time adjustments in equipment are made or operations cause one or more of the parameters for the combine configuration to change (e.g., storage capacity changing through collection and discharge of crop material as monitored by one or more sensors indicating different percent levels of content storage), along with the manufacturer data (e.g., factory measured weights). For instance, one or more data structures comprising force-associated parameters 66 may comprise pre-populated values for each of the entries 68-81. The values for entries 68-81 for these data structures may be computed each time the vehicle is started up (or the values for the data structures may be re-used if there are no updates) or when changes or updates are made to the vehicle (e.g., tire change, header installation or change-out, etc.).

In some embodiments, two sets of data structures for the acceleration force parameters 84 may be computed, one for when the unloader tube 22 is in a stowed position, and one for when the unloader tube 22 is in a fully extended position (e.g., assuming applications where the combine harvester is operating at higher speeds on a level field). In some embodiments, additional data structures for the acceleration force parameters 84 may be computed based on a plurality of intermediate stages and the fully extended position of unloader tube deployment. The acceleration force parameters 84 may be computed for a plurality of values (or ranges) for transverse acceleration 86, resulting in one embodiment, a LUT having a plurality of rows of increasing transverse acceleration values with corresponding computed, pre-populated values for the parameters 88 - 96. Then, while the vehicle is driving along level ground (e.g., as detected based on real time inputs, including in some embodiments geofence data from a portable or on-board integrated GNSS receiver), the data structure(s) corresponding to acceleration force parameters 84 may be accessed, and the controller 30 may continually or regularly (e.g., incrementally, such as every second or sub-second) compute transverse acceleration values (e.g., based on speed and acceleration) and compare the resulting G-force value to a like value or value range (e.g., a match) in one of the data structures and determine whether there is a risk of tipping that warrants a counter moment, and accordingly, apply the moment based on the tipping force parameter value (e.g., from entries 88-96) to prevent the vehicle from tipping.

In some embodiments, the one or more entries (from 88-96) that indicate a risk (e.g., based on a zero or negative value) may have a link that enables access to another data structure that has a value for the moment to be applied. In effect, the real time input is used to compute a real time value for transverse acceleration, which is used as an index into a data structure corresponding to tipping forces associated with acceleration force parameters 84 to enable determination (e.g., through access to a stored moment or one computed on-the-fly from the indication of a tipping risk) of an offsetting moment. Note that the above-described example assumes the controller 30 effects actuation via a control circuit of one of the actuators (e.g., rear left) to generate a moment (e.g., the rear axle left moment 50). In some embodiments, a moment may be achieved via activation of actuators on each side of the center pivot axis. In some embodiments, a combination of comparison of input data with pre-populated data structures and algorithmic, on-the-fly computations may be performed. Note that the above description contemplates either roadway travel or level field travel.

Though most roadway scenarios are expected to be, practically speaking, implemented by the combine harvester without the attached header, in some scenarios, a header (e.g., 25 foot wide header) may be attached (e.g., as detected according to the mechanisms described above and updated in the combine configuration 42), as is the case with travel in a field. Under such conditions, Equations 1-4 still apply, but values for the force-associated parameters 66 (and consequently values for the acceleration on COG level ground parameters 84) are updated to reflect the header information (e.g., weight or force) as indicated via updates 44. In some embodiments, the combine harvester may be travelling across a field and negotiate a turn with an implement and the unloader tube 22 deployed (e.g., where updates 44 provide an indication of the activation of the deployment), which accordingly, the force-associated parameters 66 (and consequently, the acceleration force parameters 84) will reflect force or weight values associated with the header and the deployed unloader tube 22.

Another illustration of a scenario where an embodiment of the stability control algorithm 28 applies moments via a control circuit and actuation of the actuators disposed between the chassis and rear axle to ensure stable vehicle operations involves the use of the combine harvester in the field, and in particular, when the combine harvester is parked on a slope whereby the front and rear tires on one side of the combine harvester are higher than the front and rear tires on the other side of the combine harvester. Such a circumstance may be further affected by the turning of the rear wheels and/or the deployment of the unloader tube 22. For instance, if the combine harvester is parked on the slope such that the front and rear tires on each side are at the same respective level of the slope, and if the rear wheels are turned in a direction to enable forward travel downhill, depending on the slope and/or other conditions (e.g., that change the center of mass), there may be a risk of tipping. To reduce the risk of tipping, in one embodiment, the stability control algorithm 28 determines the static forces at play in the parked position (e.g., when the park brake is deployed), and provides the appropriate moment to prevent tipping. The mechanism to determine tipping forces and providing an appropriate moment may be based on one or more data structures with pre-populated values and/or on-the-fly computations of the equations described below (in addition to data structures for the force-associated parameters 66), in similar manner to that described above in association with the acceleration force parameters 84 of FIG. 6.

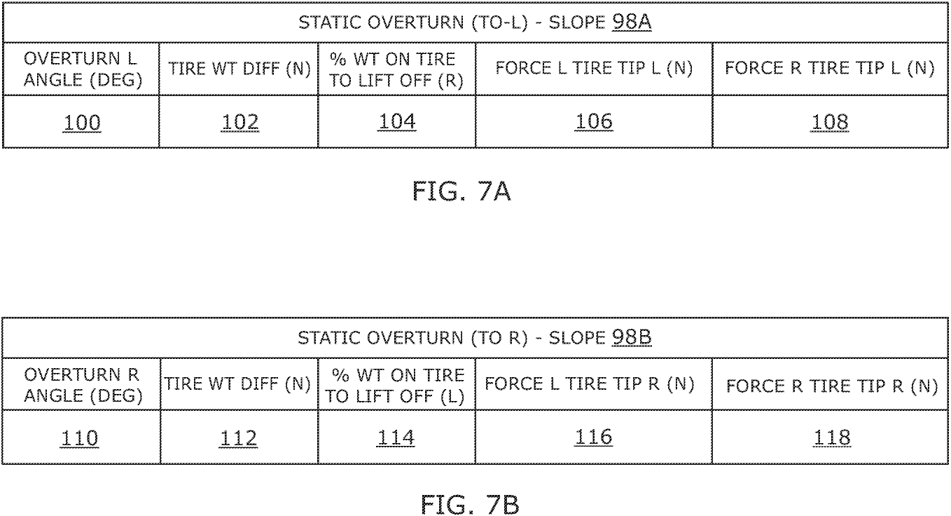

With continued reference to FIGS. 3-5, attention is directed to FIGS. 7A-7B, which illustrate tipping force determinations based on derived parameters and additional input including real time input for a vehicle having a center pivoting axis when parked on a slope. Static overturn force parameters 98 (e.g., 98A, 98B) are shown and represent computations by the controller 30 performed at least when the combine harvester has slowed to a stop and/or when the parking brake is deployed on a slope. The static overturn force parameters 98A represent the parameters where the tires on the left side (e.g., unloader tube side) of the combine harvester are lower than the right side tires, and static overturn force parameters 98B represent the parameters where the tires of the right side of the combine harvester are lower than the left side tires. The overturn left angle (in degrees) 100 represents the angular difference in amount of degrees of the left side tires relative to the right side tires (e.g., the angle of the slope), and in one embodiment, is a real time value received via a sensor corresponding to the angle of the combine 40 (FIG. 3). The tire weight difference (N) 102 represents the difference between the left tire force when tipped left (N) 106 and the right tire force when tipped left (N) 108 (e.g., [left tire tip left force 106] - [right tire tip left force 108]). The percentage weight on the right tire 104 is the percentage of the amount of weight on the right tire based on the overturn angle, and is computed according to the equation of (right tire tip left force 108) / (COG weight 78), where the COG weight 78 was described above in association with FIG. 5. The percentage weight on the right tire 104 provides an indicator of how close the combine harvester is to the right tire lifting off of the ground (e.g., as that value approaches 0%, the risk is greater of the right tire lifting off of the ground, i.e., tipping), and hence a value trending toward or close to 0% (or within some defined safety margin relative to zero, say 3%, 5%, etc.) or a negative value may be a trigger for the controller 30 to effect activation of an actuator(s) to provide a counter moment (e.g., rear axle left moment 50, FIG. 3) to prevent tipping.

The left tire tip left force (F_{LTL}) 106 and the right tire tip left force (F_{RTL}) 108 may be computed by the controller 30 according to the following equations 5 and 6, respectively:

$${\text{F}}_{\text{LTL}} \text{=} \text{f} / \text{2} \text{+} \left(\text{e*f*sin} {\text{h}}_{\text{1}}\right) / \left(\text{2*g*cos} {\text{h}}_{\text{1}}\right) \text{+} \text{b*} \text{f} / \text{2} \text{*g,} \qquad \text{(Eqn. 5)}$$

$${\text{F}}_{\text{RTL}} \text{=} \text{f} \text{-} {\text{F}}_{\text{LTL}} \text{,} \qquad \text{(Eqn. 6)}$$

where referring in part to the force-associated parameters 66 of FIG. 5, b equals COG distance from center of front axle 80, e equals COG distance vertical above ground with tires 79, f equals COG weight 77, h₁ equals overturn left angle (e.g., overturn left angle 100) divided by 57.3, and g equals ½ wheel width 76. As explained above, the values used from the force-associated parameter derivations may vary depending on the vehicle configuration (e.g., whether or not the combine harvester has a detachable implement coupled thereto, whether the unloader tube 22 is deployed, etc.).

With reference to the static overturn force parameters 98B, the overturn right angle (degrees) 110 represents the angular difference in amount of degrees on the right side tires relative to the left side tires (e.g., the slope), and in one embodiment, is a real time value received via a sensor corresponding to the angle of the combine 40 (FIG. 3). The tire weight difference (N) 112 represents the difference between the left tire force when tip right (N) 116 and the right tire force when tip right (N) 118 (e.g., [left tire force 116] - [right tire force 118]). The percentage weight on the left tire 114 is the percentage of the amount of weight on the left tire based on the overturn angle, and is computed according to the equation of (left tire force 116) / (COG weight 78). The percentage weight on the left tire 114 is used for a similar purpose (but for the other side of the combine harvester) as that described for the percentage weight of the right tire 104, and hence discussion of the same is omitted here for brevity.

The left tire tip right force (F_{LTR}) 116 and the right tire tip right force (F_{RTR}) 118 may be computed by the controller 30 according to the following equations 7 and 8, respectively:

$${\text{F}}_{\text{LTR}} \text{=} \text{f} / \text{2} \text{-} \left(\text{e*f*sin} {\text{h}}_{\text{2}}\right) / \left(\text{2*g*cos} {\text{h}}_{\text{2}}\right) \text{+} \text{b*} \text{f} / \text{2} \text{*g,} \qquad \text{(Eqn. 7)}$$

$${\text{F}}_{\text{RTR}} \text{=} \text{f} \text{-} {\text{F}}_{\text{LTR}} \text{,} \qquad \text{(Eqn. 8)}$$

where again referring at least in part to the force-associated parameters 66 of FIG. 5, b equals COG distance from center of front axle 80, e equals COG distance vertical above ground with tires 79, f equals COG weight 77, h₂ equals overturn right angle (e.g., overturn right angle 110) divided by 57.3, and g equals ½ wheel width 76.

As one example of operations, assume the combine harvester is or is about to be parked on a slope with both left-side front and rear tires at a lower level of the slope than the right-side front and rear tires. Inputs corresponding to the angle of the combine 40 (FIG. 3, e.g., using an inclination angle sensor) feeds real time information to the controller 30, and the controller computes the static overturn force parameters 98 (e.g., 98A). If the slope angle is, say, ten (10) degrees (with the left side lower than the right side), then the controller 30 may determine, for instance, that the % weight on the right tire 104 is 32% (and hence the left tire % weight is 66%). With a value of 32% on the right tire, the risk for tipping is low. On the other hand, if the slope angle is, say, thirty (30) degrees, the % weight on the right tire 104 is computed to be 0%, which means that the combine harvester is at a high risk of tipping (e.g., particularly if the operator turns the tires to the left, or if the unloader tube 22 is deployed). Accordingly, to prevent tipping, the controller 30 causes via a control circuit actuation of the left side actuator (e.g., 20A in FIG. 1A) to increase the moment force 50 on the left side tire, thus stabilizing the combine harvester by making the combine harvester more stable. As explained above, the trigger for applying the moment may be when the tipping forces are within a predetermined safety margin of 0% (e.g., within 1-2% of the % weight on the right tire 104 trending toward 0%). Note that the percentages provided above are merely for illustration, and that slope angles of ten or thirty may result in different percentages depending on the combine configuration 42 (e.g., whether the unloader tube 22 is deployed).

Note that the computations for the static overturn force parameters 98 may be performed in a manner that regularly (e.g., continuously, or sampling according to second or sub-second intervals) compares the % weight on the right tire 104 or % weight on the left tire 114 to a predefined (predetermined) threshold (e.g., 0% or 0% plus a safety margin), or in some embodiments, regularly compares the values to a data structure (e.g., a LUT), similar to the mechanisms described above. In some embodiments, the computations for the static overturn force parameters 98 may be regularly or continuously run, or in some embodiments, only invoked based on a set of conditions. For instance, the controller 30 may perform the static overturn force parameter computations responsive to the speed of the combine harvester reaching or trending to zero and the detected angle of the combine 40 (FIG. 3) having a value greater than zero or greater than a predefined slope angle (e.g., where there is a risk of tipping), or in some embodiments, via operator input (e.g., the operator knows that he is to park the combine harvester shortly). In some embodiments, only the static overturn force parameters 98A (and not the static overturn force parameters 98B) are computed based on the angle of the combine 40 (e.g., indicating that the left side is lower than the right side of the combine harvester), or vice versa.

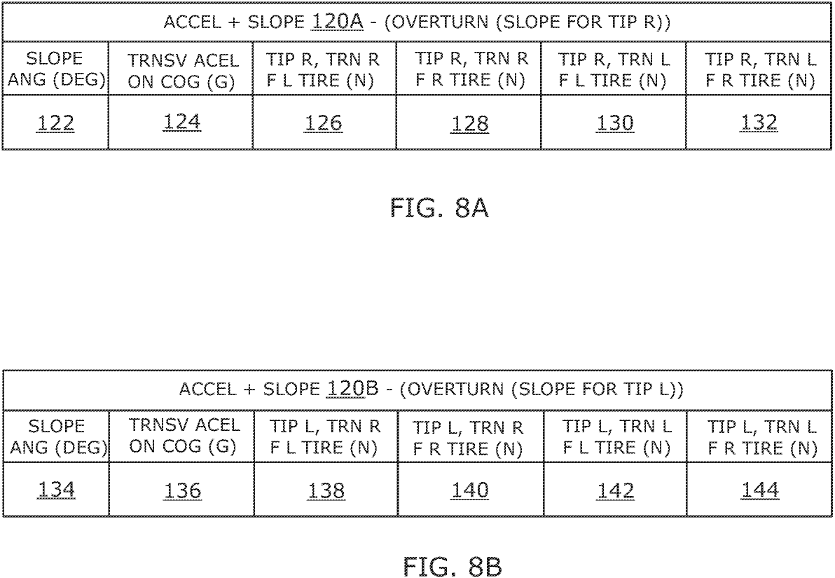

Another scenario is a combination of the above-described scenarios in that a combine harvester is traveling along a slope where one side (the left or right side) is at a higher elevation than the other side. Referring now to FIGS. 8A-8B (with continued reference to FIGS. 3-5), shown are overturn slope for tip right or left, acceleration plus slope parameters 120 (e.g., 120A, 120B, respectively) that are computed to determine tipping forces in such a scenario where the combine harvester is in motion along a slope (e.g., in a field), including negotiating a turn on the slope (e.g., with or without a deployed unloader tube 22, as would be reflected in the force-associated parameters 66). The parameters depicted in FIG. 8A are referred to hereinafter as slope motion tip right (SMTR) parameters 120A for brevity. Similarly, the parameters depicted in FIG. 8B are referred to hereinafter as slope motion tip left (SMTL) parameters 120B. The SMTR parameters 120A refer to parameters used for determining tipping forces for when the combine harvester is in motion along a slope and the right side is at a lower elevation than the left side (i.e., is tipping right). The SMTL parameters 120B refer to parameters used for determining tipping forces for when the combine harvester is in motion along a slope and the left side is at a lower elevation than the right side (i.e., is tipping left). In one embodiment, the SMTR parameters 120A include slope angle (in degrees) 122, transverse acceleration on the center of gravity (COG) 124 (e.g., G force), tip right while turning right, force on left tire (in Newtons, or N) 126, tip right while turning right, force on right tire (N) 128, tip right while turning left, force on left tire (N) 130, and tip right while turning left, force on right tire (N) 132.

The overturn slope angle 122 represents the angular difference in amount of degrees between the higher elevation left side and lower elevation right side, and in one embodiment, is a real time value received via a sensor corresponding to the angle of the combine 40 (FIG. 3). The transverse acceleration on COG 124 is a known computation of G-force that is based on real time, sensor inputs corresponding requested turning angle 36, speed 38, and angle of the combine 40 (FIG. 3). Though computations of parameter values may be performed on-the-fly as in the other parameter computations described in FIGS. 4-7B above, in some embodiments, a LUT may be pre-populated with values and real time data may be used as an index into matching parameters in the LUT(s) as similarly described above. For instance, there may be plural field entries for slope or slope range values 122, and for each overturn slope angle entry, there may be plural transverse acceleration on COG 124 values (or ranges) and corresponding force values 126, 128, 130, and 132 based on the given vehicle configuration. Real time values may be used to index into a particular set of data fields for matching slope and transverse acceleration values or ranges, where the values for the corresponding forces 126, 128, 130, and 132 may be accessed to determine the tipping force and generate an appropriate counter moment (which in some embodiments, may be a link to access a counter moment in another data structure) if needed, or computed on-on-the-fly.

Continuing with the description of the SMTR parameters 120A, the tip right while turning right, force on left tire 126, tip right while turning right, force on right tire 128, tip right while turning left, force on left tire 130, and tip right while turning left, force on right tire 132 may be computed (e.g., via on-the-fly via calculations using classical mechanics equations, via comparison to pre-populated values in a LUT as similarly explained above, or a combination thereof) to determine an appropriate moment to apply (if needed) to prevent tipping when entering a turn while in motion along a slope. The tip right while turning right, force on right tire 128, referred to below as TRTRF_{R}, may be determined according to the following Equation 9:

$$\begin{matrix}{\text{TRTRF}}_{\text{R}} \text{=} \\ \text{f} / \text{2} \text{+} \text{f*} \text{b} / \text{c} - \left(\text{f*e*sin} {\text{h}}_{\text{3}}\right) / \left(\text{c*cos} {\text{h}}_{\text{3}}\right) \text{+} {\text{a*d}}_{2} \text{*e} / \left(\text{c*cos} {\text{d}}_{\text{2}}\right) \text{,}\end{matrix} \qquad \text{(Eqn. 9)}$$

where as described in part above, a equals COG mass * 9.81, b equals COG distance from center of front axle, c equals wheel width, d₂ = transverse acceleration on COG, e equals COG distance vertical above ground with tires, f equals COG weight, and h₃ equals angle of slope divided by 57.3. Note that the variables from Equation 9 are obtained in part from the force-associated parameters 66 of FIG. 5, including COG mass (a) 78, COG distance from center of front axle (b) 80, wheel width (c) 81, COG distance vertical above ground with tires (e) 79, and COG weight (f) 77. Additional real time input are used for providing or deriving the balance of the variables of Equation 9, including the slope or h₃ 122 (FIG. 8A) divided by 57.3 and the transverse acceleration or d₂ on COG 124, as explained above.

The tip right while turning right, force on left tire 126 (or TRTRF_{L}) may be derived from Equation 10 below:

$${\text{TRTRF}}_{\text{L}} \text{=} \text{f} \text{-} {\text{TRTRF}}_{\text{R}} \text{,} \qquad \text{(Eqn. 10)}$$

where f and TRTRF_{R} are explained above.

The tip right while turning left, force on right tire 132 (or TRTLF_{R}) may be derived from Equation 11 below:

$$\begin{matrix}{\text{TRTLF}}_{\text{R}} \text{=} \\ \text{f} / \text{2} \text{+} \text{f*} \text{b} / \text{c} - \left(\text{f*e*sin} {\text{h}}_{\text{3}}\right) / \left(\text{c*cos} {\text{h}}_{\text{3}}\right) \text{-} {\text{a*d}}_{2} \text{*e} / \left(\text{c*cos} {\text{d}}_{\text{2}}\right) \text{,}\end{matrix} \qquad \text{(Eqn. 11)}$$

where the variables of Equation 11 are as described above in association with Equation 9 and omitted here for brevity.

The tip right while turning left, force on left tire 130 (or TRTLF_{L}) may be derived from Equation 12 below:

$${\text{TRTLF}}_{\text{L}} \text{=} \text{f} \text{-} {\text{TRTLF}}_{\text{R}} \text{,} \qquad \text{(Eqn. 12)}$$

where the variables are described above and omitted here for brevity.

In one embodiment, the SMTR parameters 120A are regularly computed or evaluated (e.g., via on-the-fly computations and/or comparisons to pre-populated values in a LUT(s)) to determine if there is a risk of tipping. In general, values approaching zero (or negative values) for the tipping forces 126, 128, 130, or 132 are an indication that a countering moment is needed of at least a corresponding magnitude (and in some embodiments, an additional force within a predetermined margin of safety) on the opposing side (of the pivot axis) of the tire that is at risk of lifting off of the ground to keep the at risk tire(s) from lifting off the ground. In effect, the requested steering angle may correspond to a transverse acceleration that adds to the tipping force associated with the combine harvester travelling along the slope, and hence the combined tipping forces need to be countered with a suitable moment. For instance, assume as an illustrative example that the combine harvester is in field mode, has coupled thereto a 25 ft. Dynaflex header on the front, and receives real time input of a commanded steering angle to perform a right turn that results in a G force (transverse acceleration) of 0.4 Gs at the COG while travelling on a left angled slope of 10 degrees. In one embodiment, the controller 30, knowing based on real time input of the tipping angle (tip right), computes the equations associated with the forces 126, 128, 130, 132 in FIG. 8A (or indexes a pre-populated LUT based on a match to a set of values corresponding to the current requested steering angle and speed and slope) and determines the value for TRTLF_{L} (Eqn. 12) is approximately (-) 26887 N, which corresponds to the left tire lifting off of the ground, and hence prompts the controller 30 to cause a moment to be applied via a control circuit and actuator on the rear right axle 48 (FIG. 3) to prevent the left tire from lifting off of the ground. For instance, the controller 30 triggers pressurized flow (via the control circuit) to the tilt rear axle right cylinder (actuator), wherein in one embodiment, the flow is continually applied until sensors associated with the cylinder pressure feed back signals to the controller 30 that pressure is at a sufficient level.

FIG. 8B is illustrative of the SMTL parameters 120B. In one embodiment, the SMTL parameters 120B include slope angle (in degrees) 134, transverse acceleration on the center of gravity (COG) 136 (e.g., G force), tip left while turning right, force on left tire (N) 138, tip left while turning right, force on right tire (N) 140, tip left while turning left, force on left tire (N) 142, and tip left while turning left, force on right tire (N) 144.

The overturn slope angle 134 represents the angular difference in amount of degrees between the higher elevation right side and lower elevation left side, and in one embodiment, is a real time value received via a sensor corresponding to the angle of the combine 40 (FIG. 3). The transverse acceleration on COG 136 is a known computation of G-force that is based on real time, sensor inputs corresponding to requested turning angle 36, speed 38, and angle of the combine 40 (FIG. 3). As similarly described in association with the SMTR parameters 120A, parameter computations may be performed on-the-fly or pre-populated in a LUT for comparison to real time input values, and hence discussion of the same is omitted here for brevity.

Continuing with the description of the SMTL parameters 120B, the tip left while turning right, force on left tire 138, tip left while turning right, force on right tire 140, tip left while turning left, force on left tire 142, and tip left while turning left, force on right tire 144 may be computed via on the fly via calculations using classical mechanics equations or pre-populated in a LUT for comparison to real time input, as similarly explained above, to determine an appropriate moment to apply (if needed) to prevent tipping when entering a turn while in motion along a slope. The tip left while turning right, force on left tire 138, referred to below as TLTRF_{L}, may be determined according to the following Equation 13 below:

$$\begin{matrix}{\text{TLTRF}}_{\text{L}} \text{=} \\ \text{f} / \text{2} \text{+} \text{f*} \text{b} / \text{c} + \left(\text{f*e*sin} {\text{h}}_{\text{4}}\right) / \left(\text{c*cos} {\text{h}}_{\text{4}}\right) \text{+} {\text{a*d}}_{3} \text{*e} / \left(\text{c*cos} {\text{d}}_{\text{3}}\right) \text{,}\end{matrix} \qquad \text{(Eqn. 13)}$$

where a equals COG mass * 9.81, b equals COG distance from center of front axle, c equals wheel width, d₃ = transverse acceleration on COG, e equals COG distance vertical above ground with tires, f equals COG weight, and h₄ equals angle of slope divided by 57.3. Note that the variables from Equation 13 are obtained in part from the force-associated parameters 66 of FIG. 5, including COG mass (a) 78, COG distance from center of front axle (b) 80, wheel width (c) 81, COG distance vertical above ground with tires (e) 79, and COG weight (f) 77. Additional real time input are used for providing or deriving the balance of the variables of Equation 13, including the slope or h₄ 134 (FIG. 8B) divided by 57.3, and the transverse acceleration on COG or d₃ 136, as explained above.

The tip left while turning right, force on right tire 140 (or TLTRF_{R}) may be derived from Equation 14 below:

$${\text{TLTRF}}_{\text{R}} \text{=} \text{f} - {\text{TRTRF}}_{\text{L}} \text{,} \qquad \text{(Eqn. 14)}$$

where f and TRTRF_{L} are explained above.

The tip left while turning left, force on left tire 142 (or TLTLF_{L}) may be derived from Equation 15 below:

$$\begin{matrix}{\text{TLTLF}}_{\text{L}} \text{=} \\ \text{f} / \text{2} \text{+} \text{f*} \text{b} / \text{c} + \left(\text{f*e*sin} {\text{h}}_{\text{4}}\right) / \left(\text{c*cos} {\text{h}}_{\text{4}}\right) \text{-} {\text{a*d}}_{3} \text{*e} / \left(\text{c*cos} {\text{d}}_{\text{3}}\right) \text{,}\end{matrix} \qquad \text{(Eqn. 15)}$$

where the variables for Equation 13 are as described above in association with Equation 13 and omitted here for brevity.

The tip left while turning left, force on right tire 144 (or TLTLF_{R}) may be derived from Equation 16 below:

$${\text{TLTLF}}_{\text{R}} \text{=} \text{f} - {\text{TLTLF}}_{\text{L}} \text{,} \qquad \text{(Eqn. 16)}$$

where the variables are described above and omitted here for brevity.

In one embodiment, the SMTL parameters 120B are regularly computed or evaluated (e.g., on-the-fly or via a LUT, as similarly described above) to determine if there is a risk of tipping. In general, values of zero or negative values for the tipping forces 138, 140, 142, or 144 are an indication that a countering moment is needed of at least a similar magnitude (and in some embodiments, an additional force within a predetermined margin of safety) on the opposing side (of the pivot axis) of the tire that is at risk of lifting off of the ground to keep the at risk tire(s) from lifting off the ground. In effect, the requested steering angle is a tipping force that may be in addition to the tipping force that is associated with the combine harvester travelling along the slope, and hence the combined force needs to be countered with a suitable moment.

The Equations 1-16 described above provide different values and results depending on the combine configuration 42 (with updates 44) and/or the real time inputs. For instance, a combine harvester in a static state along a slope may experience a lower tipping risk than if in a similar orientation and state yet with the unloader tube extended. The force-associated parameters 66 are updated to compensate for these different forces. Note that the equations set forth above are examples of derivations of forces using mechanical physics equations, and that the specific form of one or more of the equations may be modified to provide a same or similar (e.g., a rounded or less exact) result or effect, and hence are contemplated to be within the scope of the disclosure.

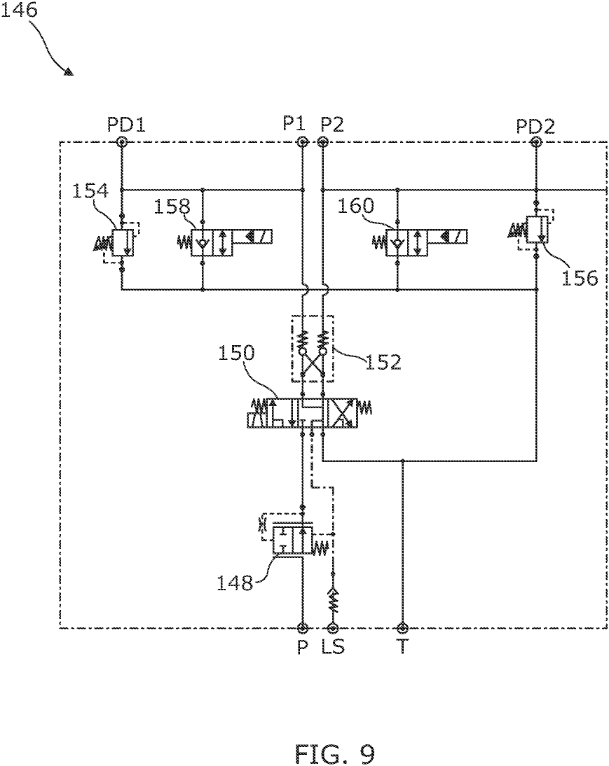

Attention is now directed to FIG. 9, which is a schematic diagram of an embodiment of a control circuit 146 used for effecting actuation of one or more actuators based on tipping force determinations. The control circuit 146 is somewhat similar to existing control circuits for the lateral tilt for headers on the combine harvester. Note that variations to the type and/or quantity of components for the control circuit 146, in the same or different arrangement, may be used according to hydraulic control methodologies known to those having ordinary skill in the art, and hence are contemplated to be within the scope of the disclosure. Reviewing from the bottom of FIG. 9, P LS, and T refer to a pump pressure (supplying the control circuit 146), a load sense signal that signals to a pump a required operating pressure, and a return line to a hydraulic fluid reservoir, respectively. The fluid is directed through a float compensator 148, which is configured to ensure a constant or substantially constant fluid flow regardless of pump pressure variations. Fluid through the float compensator 148 is directed to a 3-position control value 150, which is configured to route fluid to a left or right cylinder (actuator, such as a piston-rod type cylinder) and hence control which side of an axle center pivot to apply a moment. From the 3-position control valve, the fluid is further routed through a power-operated check valve circuit 152, which preserves the pressure on the right or left cylinders when the control valve 150 returns to a center spool position. Note that control valve 150 comprises a primary valve for receiving signals from one or more controllers 30 and causing flow to a left or right cylinder.

The control circuit 146 further comprises left and right relief valves 154, 156, which are configured to release fluid if exerted moments cause excessive pressure on the tires (e.g., to cause the tire to burst). In some embodiments, the relief valves 154, 156 further comprise controls for providing an alarm. Control valves 158 and 160 are configured to enable normal operating, rear center pivoting action. PD1 and PD2 comprise respective locations for pressure transducers that provide feedback to the controller 30 (FIG. 3), closed-loop control to ensure the forces sent to the left and right cylinders are correct. In other words, transducers at PD1 and PD2 sense the hydraulic cylinder pressures that are fed back to the controller 30. P1 and P2 comprise the outputs to the cylinders. For instance, P1 provides fluid to a base side of a left cylinder and a rod side to the right cylinder, whereas P2 is the reverse. Note that one or more of the control valves 150, 158, and/or 160 may comprise an interface with suitable controls (e.g., electronic and/or electromagnetic circuits, including solenoids) that cooperate through signaling with the controller 30 to enable application of suitable moments. Control may be achieved using 4-20 mA control signals or 0.5-4.5 V, among other control schemes. Further, in some embodiments, other mechanisms may be used in place of the hydraulic fluid, including pneumatic or electrical control. Also, the quantity of valves or arrangement of the valves may differ than that depicted or described in association with FIG. 9 to perform similar functionality, as would be appreciated by one having ordinary skill in the art.

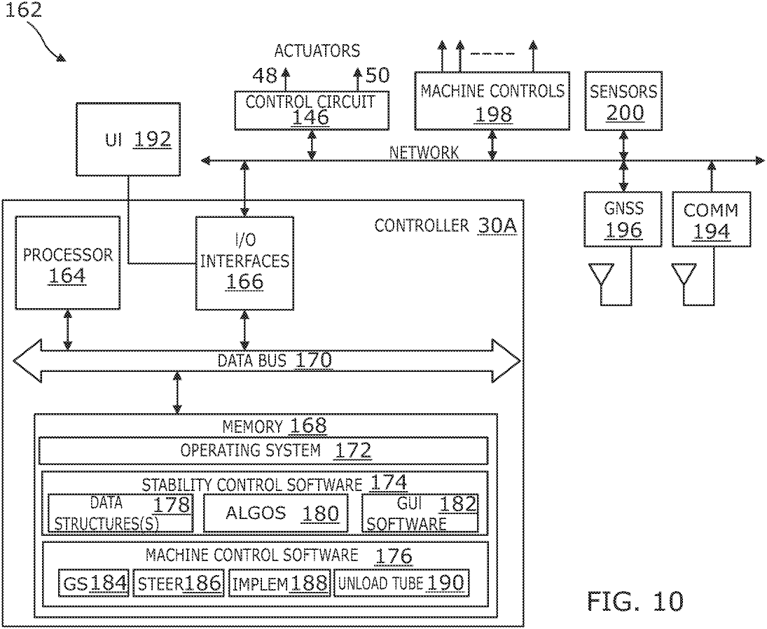

Referring now to FIG. 10, shown is a block diagram that illustrates an embodiment of an example stability control system 162. One having ordinary skill in the art should appreciate in the context of the present disclosure that the example stability control system 162 is merely illustrative, and that some embodiments may comprise fewer or additional components, and/or some of the functionality associated with the various components depicted in FIG. 10 may be combined, or further distributed among additional modules and/or computing devices (e.g., plural controllers), in some embodiments. It should be appreciated that, though described primarily in the context of residing in the combine harvester, in some embodiments, one or more of the functionality of the stability control system 162 may be implemented in a computing device or devices internal and external to the combine harvester, or completely external to the combine harvester. The stability control system 162 comprises a controller 30A communicatively coupled to plural components via a network. The controller 30A, which is an embodiment of controller 30 described in association with FIG. 3, is depicted in this example as a computer device (e.g., an electronic control unit or ECU), but may be embodied as a programmable logic controller (PLC), field programmable gate array (FPGA), application-specific integrated circuit (ASIC), among other devices, including implemented as plural devices. It should be appreciated that certain well-known components of computer systems are omitted here to avoid obfuscating relevant features of the controller 30A.

In one embodiment, the controller 30A comprises one or more processors, such as processor 164, input/output (I/O) interface(s) 166, and memory 168, all coupled to one or more data busses, such as data bus 170. The memory 168 may include any one or a combination of volatile memory elements (e.g., random-access memory RAM, such as DRAM, and SRAM, etc.) and nonvolatile memory elements (e.g., ROM, Flash, hard drive, EPROM, EEPROM, CDROM, etc.). The memory 168 may store a native operating system, one or more native applications, emulation systems, or emulated applications for any of a variety of operating systems and/or emulated hardware platforms, emulated operating systems, etc.

In the embodiment depicted in FIG. 10, the memory 168 comprises an operating system 172, stability control software 174, and machine control software 176. In one embodiment, the stability control software 174 carries out (along with the processor 164 and other components as described below) the functionality of the stability control algorithm 28 described in association with FIG. 3. The stability control software 174 comprises one or more data structures 178 (e.g., look up table(s) or LUT(s)), algorithms 180 (e.g., equations), and graphical user interface (GUI) software 182. The data structure(s) 178 are described above in association with FIGS. 4-8B, and may comprise manufacturer data (e.g., factory specifications, including weights) and information corresponding to the parameters shown in FIGS. 4-8B. For instance, the combine configuration data structure 42A (FIG. 4A) may be included as part of the data structures 178. The data structures 178 may further include a data structure for the force-associated parameters 66 (FIG. 5) that are derived from the combine configuration data structure 42A and manufacturer data.

In some embodiments, there may be plural data structures for the force-associated parameters 66 corresponding to the combine configuration 42A and manufacturer data for various configurations of the combine harvester, including with a header attached, without a header attached, with the unloader tube deployed, with the unloader tube stowed, etc. From the information gleaned from the force-associated parameters and manufacturer data, the controller 30A may pre-populate plural data structures corresponding to the parameters depicted in, and described in association with, FIGS. 6-8B. For instance, the data structures 178 may include pre-populated values (e.g., 88, 90, 92, 94, and 96, FIG. 6) of the acceleration force parameters 84 (FIG. 6) for plural predetermined values (plural entries) of transverse acceleration values or range of values.

In one embodiment, the controller 30A may receive (e.g., from sensors) real time information (e.g., turning angle 36, speed 38, and angle of inclination 40), use that information to determine the current transverse acceleration (e.g., real time G-force computation), compare the real time computed value to the plural pre-populated field entries corresponding to plural transverse acceleration values or ranges, and select a row entry (or column entry) that has a pre-computed transverse acceleration value (or range) that matches the computed real time transverse acceleration value (or is within a range). Based on the match, the controller 30A can determine if there is a risk of tipping based on the corresponding force parameter values and take the necessary action (e.g., derive or access a (pre-computed) counter moment and apply the moment to the appropriate side of the rear axle). In some embodiments, instead of pre-populating the derived tipping force (e.g., using FIG. 6 as an example), entries may include values that signify the need for a counter moment (e.g., a flag or syntax that links to another data structure for a derived counter moment value, or instead, a an explicit counter moment value, when a moment is needed, or a value corresponding to no moment being required). These and/or other mechanisms for arranging the data structure(s) to determine the tipping risk and derive or access a suitable moment to apply to the rear axle to prevent tipping may be used, and hence are contemplated to be within the scope of the disclosure.

In a similar manner as described above, the data structures 178 may comprise pre-populated values or ranges for the parameters associated with FIGS. 7A-8B (e.g., plural pre-determined tipping force-related values for plural pre-determined overturn angle entries in FIGS. 7A-7B, plural pre-determined tipping force-related values for plural pre-determined slope, overturn angle, and transverse acceleration values or ranges, etc.), where real time data is compared to the entries to determine if a counter moment is needed or not and then computing or accessing a moment. In some embodiments, one or more data structures 178 may be limited to a sub-set of the parameters shown in FIGS. 4-8B. For instance, at vehicle start-up or upon equipment changes that are detected or stored via user input at an input interface, the parameters of the combine configuration 42A may be stored in the data structures 178, the force-associated parameters 66 derived based on the combine configuration 42A, including any updates 44, and manufacturer data, and stored in the data structures (e.g., for various combine harvester configurations), and then the parameters associated with FIGS. 6-8B are computed on-the-fly as described above and below. Other delineations of what is stored in a data structure 178 and what is computed on-the-fly (via algorithms 180) may be used, and hence are contemplated to be within the scope of the disclosure.

In some embodiments, the algorithms 180 may be used to derive parameters on-the-fly based on real time inputs and combine configurations 42A (including updates 44). The algorithms 180 may include classical physics equations and Equations 1-16. For instance, at vehicle start-up or based on updates 44 (e.g., via any equipment changes, changes during field operations, etc.), the force-associated parameters 66 (FIG. 5) may be computed and stored in data structures 178. Then, based on real time input, parameters associated with any of FIGS. 5-8B may be computed by algorithms 180 (e.g., using one of Equations 1-16). In some embodiments, a combination of pre-populated data structures 178 and on-the-fly computations using algorithms 180 may be implemented.

The GUI software 182 may be used to provide feedback to an operator (or remote control personnel) when moments are applied, or when there is a trending risk. In some embodiments, the GUI software 182 may provide an interface for an operator to control the feel of the ride (e.g., choose a standard or more aggressive stability control). In some embodiments, the GUI software 182 may be omitted for purposes of tipping control.

The machine controls software 176 comprises plural software to control functioning of the combine harvester, including ground speed control software 184, steering software (e.g., including in some embodiments, autonomous or semi-autonomous, GNSS-based steering) 186, implement (e.g., header) operation control software 188 (e.g., header tilt, header lift, etc.), and unloader tube software 190. It should be appreciated that one or more additional software functionality may be included in memory 168, including communications software/telemetry, browser software, GNSS software, etc. In some embodiments, the aforementioned software may be located elsewhere (e.g., in separate, persistent memory), or distributed among several locations (e.g., within and/or external to the combine harvester).

To controller 30A communicates with one or more hardware and/or software components via the I/O interfaces 166 and a network (e.g., a controller area network (CAN) bus, including a CAN system, such as a network in conformance to the ISO 11783 standard, also referred to as “Isobus).

The I/O interfaces 166 provide one or more interfaces to the CAN bus (network) and/or other networks. In other words, the I/O interfaces 166 may comprise any number of interfaces for the input and output of signals (e.g., comprising analog or digital data) for conveyance of information (e.g., data) over one or more networks. The input may comprise input by an operator residing in a cab of the combine harvester through a user interface 192, which may include switches, touch-screen, FNR joystick, keyboard, steering wheel, headset, immersive headset, mouse, microphone/speaker, display screen, among other types of input devices. In some embodiments, input via the I/O interfaces 192 may additionally or alternatively be received from a remote device. For instance, remote control of combine operations may be achieved via control signals communicated from a remote device to a communications interface 194 coupled to the network, which in turn provides a communications medium (e.g., wired and/or wireless) by which data is transferred to the controller 30A via the I/O interfaces 166.

The communications interface 194 may comprise one or more antennas, a radio modem, cellular modem, or a combination of both. The communications interface 194 may cooperate with communications software (not shown) residing in memory 168 (e.g., GSM protocol stack, 802.11 software, etc.) to enable the transmission and/or reception of data (e.g., commands) over a cellular or wireless local area network (LAN). Input data received by the controller 30A via the I/O interfaces 166 may also include positional or location data, including data received from a GNSS (global navigation satellite systems) receiver 196 coupled to the CAN or other network. In some embodiments, positional or location information may be achieved through other techniques, including triangulation using the communications interface 194 or dead-reckoning techniques via inertial components (e.g., accelerometers, gyroscopes, etc.).

The control circuit 146 has been described above, and is used to control actuators (e.g., actuators 20) to effect moments 48, 50 (FIG. 3), the actuators comprising piston-rod type hydraulic actuators, though other styles, including air-powered actuators (e.g., actuators 24) using other forms of power may be used in some embodiments. As explained above, various components of the control circuit 146 comprise interfaces (e.g., circuitry, including a solenoid or motor) that are in communication (wirelessly or via a wired connection) with the controller 30A, and which receive instructions from the stability control software 174 to apply a moment to the left or right side of the rear axle based on the determination of tipping risks.

Guidance software located in memory 168 may be used in conjunction with the steering control software 186 to actuate steering mechanisms of machine controls 198 (e.g., steering cylinders in conjunction with steering valve actuators/valves or motors) for autonomous or semi-autonomous steering control of the combine harvester.

Sensors 200 may include steering sensors that are used to communicate a steering command to the steering control software 186, and may also be used in the stability control software 174 to receive a requested steering angle (e.g., turning angle 36, FIG. 3) and determine transverse acceleration, etc. Sensors 200 may include an inclination sensor that provides an angle of the combine 40 (FIG. 3) to the stability control software 174, which may be used in slope tipping force computations. The sensors 200 may also include a ground speed sensor to communicate ground speed 38 (FIG. 3) to the stability control software 174,which also may be used in determining transverse acceleration on level or sloped surfaces. Additional sensors 200 that provide input to the stability control software 174 include sensors that are used to detect a status of implement (e.g., header) attachment, identification, specifications (e.g., weight, dimensions), positioning (e.g., raised or lowered, tilted, etc.), sensors that detect bin storage capacity status (e.g., percent filled), sensors that detect tire change-outs (e.g., to sensor or prompt inspection and updates of the tire dimensions), and sensors to detect the deployment of the unloader tube 22 (FIG. 1). As these sensors are explained above, further discussion of the same is omitted for brevity. The various sensors 200 may comprise any one of a plurality of different types depending on the application, and include ground speed sensors, positional sensors, angle sensors (e.g., rotary encoders), load sensors, acoustic sensors, and/or optical sensors (e.g., array or strip sensors, LIDAR, cameras). In some embodiments, one or more sensors 200 may be integrated in part in cylinders of the actuators (e.g., 20, 24, FIGS. 1A, 1B) (e.g., providing feedback of stroke position).

Execution of the stability control software 174 and the machine controls software 176 (among other software of the controller 30A) may be implemented by the processor 164 under the management and/or control of the operating system 172. The processor 164 may be embodied as a custom-made or commercially available processor, a central processing unit (CPU) or an auxiliary processor among several processors, a semiconductor based microprocessor (in the form of a microchip), a macroprocessor, one or more application specific integrated circuits (ASICs), a plurality of suitably configured digital logic gates, and/or other well-known electrical configurations comprising discrete elements both individually and in various combinations to coordinate the overall operation of the controller 30A.

When certain embodiments of the controller 30A are implemented at least in part as software (including firmware), as depicted in FIG. 10, it should be noted that the software can be stored on a variety of non-transitory computer-readable medium (including memory 168) for use by, or in connection with, a variety of computer-related systems or methods. In the context of this document, a computer-readable medium may comprise an electronic, magnetic, optical, or other physical device or apparatus that may contain or store a computer program (e.g., executable code or instructions) for use by or in connection with a computer-related system or method. The software may be embedded in a variety of computer-readable mediums for use by, or in connection with, an instruction execution system, apparatus, or device, such as a computer-based system, processor-containing system, or other system that can fetch the instructions from the instruction execution system, apparatus, or device and execute the instructions.

When certain embodiment of the controller 30A are implemented at least in part as hardware, such functionality may be implemented with any or a combination of the following technologies, which are all well-known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Note that in some embodiments, the functionality of the stability control software 174 may be performed entirely in the combine harvester, or in some embodiments, one or more functionality of the stability control software 174 may be achieved via distributed processing (e.g., achieved using plural controllers co-located in the combine harvester or via plural controllers and/or computing devices located in different locations (e.g., in the field on the combine harvester and in a field office or corporate facility).

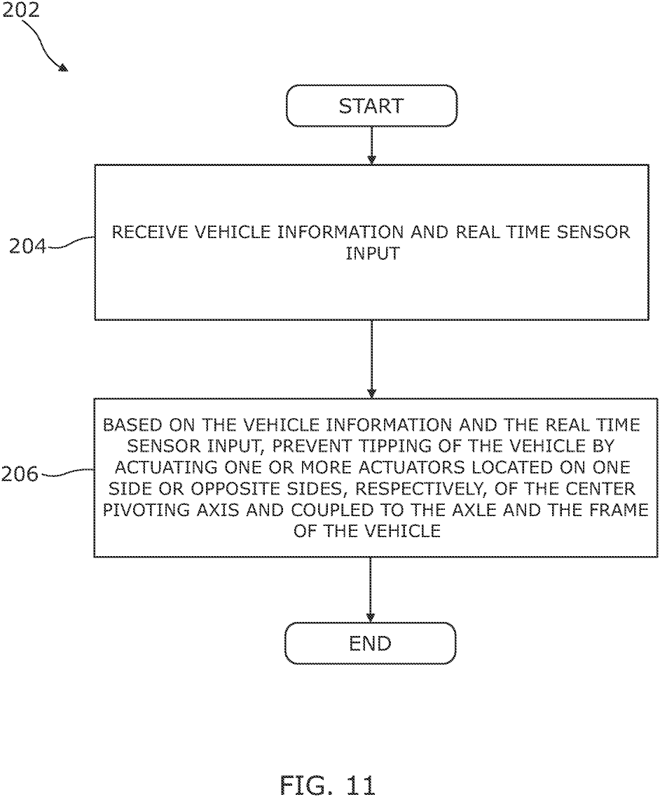

In view of the above description, it should be appreciated that one embodiment of an example stability control method 202, depicted in FIG. 11 (and implemented in one embodiment by the controller 30, 30A (FIG. 3, FIG. 10), comprises a method for preventing a vehicle from tipping, the vehicle comprising an axle having a center pivoting axis and a frame coupled to the axle at the center pivoting axis. In one embodiment, the method 202 comprises receiving vehicle information and real time sensor input (204); and based on the vehicle information and the real time sensor input, preventing tipping of the vehicle by actuating one or more actuators located on one side or opposite sides, respectively, of the center pivoting axis and coupled to the axle and the frame of the vehicle (206). For instance, as explained above, a single actuator may be used in cooperation with the linkage, or actuators disposed on each side of the linkage may be used. Also, vehicle information may include manufacturer data, and computed parameters (e.g., as described in association with FIGS. 4-8B) associated with the computation of tipping forces for various vehicle conditions.

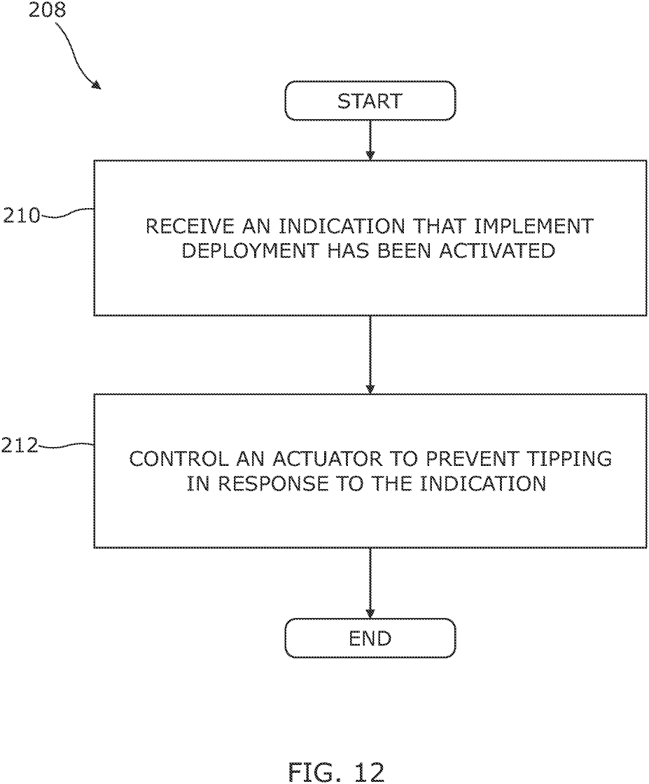

In view of the above description, it should be appreciated that another embodiment of an example stability control method 208, depicted in FIG. 12 (and implemented in one embodiment by the controller 30, 30A (FIG. 3, FIG. 10), comprises a method for preventing a vehicle from tipping, the vehicle comprising an axle having a center pivoting axis, a frame coupled to the axle at the center pivoting axis, and an implement coupled to the frame and configured to pivot away from the frame from a stowed position to a deployed position, the method comprising receiving an indication that the implement deployment has been activated (210); and controlling an actuator to prevent tipping in response to the indication (212).

Any process descriptions or blocks in flow diagrams should be understood as representing modules, segments, or portions of code which include one or more executable instructions for implementing specific logical functions or steps in the process, and alternate implementations are included within the scope of the embodiments in which functions may be executed out of order from that shown or discussed, including substantially concurrently or in reverse order, depending on the functionality involved, as would be understood by those reasonably skilled in the art of the present disclosure.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein. Although the systems and methods have been described with reference to the example embodiments illustrated in the attached drawing figures, it is noted that equivalents may be employed and substitutions made herein without departing from the scope of the disclosure as protected by the following claims.

1. A vehicle, comprising:
a frame;
an axle coupled to the frame at a center pivoting axis;
a controller;
a sensor in communication with the controller;
an actuator coupled to the axle and the frame;
a control circuit comprising one or more control valves coupled to the actuator, each of the one or more control valves comprising an interface configured to receive control signals from the controller, wherein the controller is configured to control the actuator to apply a moment to the axle relative to the frame in response to input from the sensor to prevent tipping based on forces imposed on the vehicle.

2. The vehicle of claim 1, wherein the actuator comprises a hydraulic actuator, an air-type actuator, or a motor.

3. The vehicle of claim 1, wherein the controller is configured to receive a first set of parameters corresponding to features of the vehicle.

4. The vehicle of claim 3, wherein the first set of parameters comprises one or more of tire dimensions, drive configuration, implement dimensions, implement connection status, storage dimensions, or storage capacity status.

5. The vehicle according to claim 3, wherein at least one of the parameters of the first set of parameters is sensed by the sensor.

6. The vehicle of claim 3, wherein the controller is configured to derive a second set of parameters based on the first set of parameters, the second set of parameters comprising one or more of front axle weight, rear axle weight, left and right side forces, wheel base dimensions, center of gravity weight, center of gravity mass, or center of gravity distance above ground.

7. The vehicle of claim 6, wherein the controller is configured to determine, based on the second set of parameters and real time input, vehicle tipping forces when the vehicle is in motion, and to effect actuation of the actuator based on the determination, wherein the real time input comprises sensor input corresponding to ground speed and a steering angle.

8. The vehicle of claim 6, wherein the controller is configured to determine, based on the second set of parameters and real time input, vehicle tipping forces when the vehicle is not in motion and the vehicle is located on a slope, and to effect actuation of the actuator based on the determination, wherein the real time input comprises a steering angle and an angle of inclination of the vehicle.

9. The vehicle of claim 6, wherein the controller is configured to determine, based on the second set of parameters and real time input, vehicle tipping forces when the vehicle is in motion and the vehicle is located on a slope, and to effect actuation of the actuator based on the determination, wherein the real time input comprises ground speed, a steering angle, and an angle of inclination of the vehicle.

10. The vehicle of claim 1, wherein the vehicle is a combine harvester with, fore and aft, a cab and a storage bin, wherein the actuator is disposed rearward of the storage bin.

11. The vehicle of claim 10, further comprising an unloader tube coupled to the frame and configured to pivot away from the frame from a stowed position to a deployed position.

12. The vehicle of claim 11, wherein the actuator is located on a same side of the center pivoting axis as the unloader tube, wherein in response to activating deployment of the implement from the stowed position, the actuator is configured by the controller to prevent tipping.

13. The vehicle of claim 3, wherein the first set of parameters includes an unloader tube status that represents whether the unloader tube is in the deployed position or the stowed position.

14. The vehicle of claim 1, further comprising an additional actuator located on the other side of the pivoting axis and coupled to the frame and the axle.

15. A control system for a vehicle comprising an axle having a center pivoting axis and a frame coupled to the axle at the center pivoting axis, the control system comprising:
a controller;
a control circuit; and
one or more actuators located on one side or opposite sides, respectively, of the center pivoting axis and coupled to the axle and the frame of the vehicle, the one or more actuators configured by the controller and the control circuit to prevent tipping based on forces imposed on the vehicle.

16. The control system of claim 15, further comprising one or more sensors communicatively coupled to the controller, the control circuit comprising one or more control valves coupled to the one or more actuators, each of the one or more control valves comprising an interface configured to receive control signals from the controller based on sensor input.

17. The control system of claim 15, wherein the controller is further configured to:
receive a first set of parameters corresponding to features of the vehicle; and
derive a second set of parameters based on the first set of parameters,
wherein the first set of parameters comprises one or more of tire dimensions, drive configuration, implement dimensions, implement connection status, storage dimensions, or storage capacity status,
wherein the second set of parameters comprises one or more of front axle weight, rear axle weight, left and right side forces, wheel base dimensions, center of gravity weight, center of gravity mass, or center of gravity distance above ground.

18. The control system of claim 17, wherein the vehicle is configured to receive a detachable front implement, and wherein the controller is further configured to:
determine, based on the second set of parameters and real time input, vehicle tipping forces when the vehicle is or is not in motion, the vehicle does or does not have a detachable front implement attached to the vehicle, and the vehicle is located on a slope; and
effect actuation, via the control circuit, of the one or more actuators based on the determination, wherein the real time input comprises ground speed, a steering angle, and an angle of inclination of the vehicle.

19. The control system of claim 17, wherein the vehicle is configured to receive a detachable front implement, and wherein the controller is further configured to:
determine, based on the second set of parameters and real time input, vehicle tipping forces when the vehicle is in motion and the vehicle does or does not have a detachable front implement attached to the vehicle; and
effect actuation, via the control circuit, of the one or more actuators based on the determination, wherein the real time input comprises sensor input corresponding to ground speed and a steering angle.

20. A method for preventing a vehicle from tipping, the vehicle comprising an axle having a center pivoting axis and a frame coupled to the axle at the center pivoting axis, the method comprising:
receiving vehicle information and real time sensor input; and
based on the vehicle information and the real time sensor input, preventing tipping of the vehicle by actuating one or more actuators located on one side or opposite sides, respectively, of the center pivoting axis and coupled to the axle and the frame of the vehicle.
